(19) United States
(12) Patent Application Publication
(10) Pub. No.: US 2025/0147523 A1
(43) Pub. Date: May 8, 2025

(54) MODULAR VEHICLE MANAGEMENT SYSTEM

(71) Applicant: Anduril Industries, Inc., Costa Mesa, CA (US)

(72) Inventors: Adam Christopher Grelck, Creve Coeur, MO (US); Edward F. Carter, III, San Diego, CA (US); Daniel Lee George, Beaverton, OR (US)

(21) Appl. No.: 18/926,182

(22) Filed: Oct. 24, 2024

Related U.S. Application Data
(60) Provisional application No. 63/597,106, filed on Nov. 8, 2023.

(51) Int. Cl. G05D 1/86; G05D 1/60; G05D 101/00; G05D 109/10; G05D 111/30; H04W 4/46

(52) U.S. Cl. CPC G05D 1/86; G05D 1/60; H04W 4/46; G05D 2101/24; G05D 2109/10; G05D 2111/32

(57) ABSTRACT

A modular vehicle management system includes a vehicle management board configured to interface with any of a plurality of vehicle-specific boards. The vehicle management board includes connectors configured to receive operational data from a vehicle-specific board and to send control data to the vehicle-specific board. The vehicle management board includes processors configured to receive the operational data, generate the control data, and send the control data to the vehicle specific board. The vehicle-specific board includes connectors configured to interface with computing devices, connectors configured to interface with the connectors on the vehicle management board to convey operational data and receive control data, and connectors configured to interface with controllers of the vehicle.

### CROSS-REFERENCE TO RELATED APPLICATIONS

This application claims benefit of U.S. Provisional Patent Application No. 63/597,106, filed Nov. 8, 2023, and titled “MODULAR VEHICLE MANAGEMENT SYSTEM.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57.

### TECHNICAL FIELD

Implementations of the present disclosure relate to modular vehicle management systems and methods for vehicles, such as autonomous, semi-autonomous, or unmanned vehicles. Implementations of the present disclosure further relate to a vehicle management computer for generating control instructions for vehicles.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Autonomous vehicles, semi-autonomous vehicles, unmanned vehicles, and/or the like, may be used for a plurality of applications. Such applications may include commercial applications including surveillance, filming, and delivery, as well as military applications including reconnaissance and tactical missions. The various applications may utilize different vehicle types, including for example autonomous vehicles, semiautonomous vehicles, unmanned vehicles, arial vehicles (e.g., unmanned aerial vehicles (“UAVs”), vertical take-off and landing (“VTOL”) aircraft, and/or the like), aquatic vehicles (e.g., submarines, ships, and/or the like), land vehicles (e.g., cars, offroad vehicles, and/or the like), other types of vehicles, and/or any combination of the foregoing.

Different vehicle types may have different components, operating constraints, and/or the like. As such, it may be challenging to utilize research and development from one vehicle type in another vehicle type.

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1A illustrates a block diagram of an example computing environment of a vehicle management system, according to various implementations of the present disclosure;

FIG. 1B illustrates a block diagram of an example vehicle-specific board, according to various implementations of the present disclosure;

FIG. 1C illustrates a block diagram of an example vehicle management board, according to various implementations of the present disclosure;

FIG. 2 illustrates a block diagram of an example partition of a mission critical domain and a safety critical domain, according to various implementations of the present disclosure;

FIG. 3 illustrates a block diagram of an example software environment of the vehicle management system for executing a vehicle management program, according to various implementations of the present disclosure;

FIG. 4 illustrates an example implementation of a vehicle-specific board and vehicle management board, according to various implementations of the present disclosure;

FIG. 5 illustrates a flow diagram depicting example functionality of the vehicle management system, according to various implementations of the present disclosure;

FIG. 6 is a flow chart depicting an example flow, method, operation, and/or functionality of the vehicle management system, according to various implementations of the present disclosure;

FIG. 7 is a flow chart depicting an example flow, method, operation, and/or functionality of the vehicle management system, according to various implementations of the present disclosure;

FIG. 8 is a flow chart depicting an example flow, method, operation, and/or functionality of the vehicle management system, according to various implementations of the present disclosure; and

FIG. 9 illustrates a block diagram of an example operational environment, according to various implementations of the present disclosure.

### DETAILED DESCRIPTION

Although certain implementations and examples are disclosed below, inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

Described herein is a vehicle control and/or management system (generally referred to herein as the “vehicle management system” or the “system”) that can be used across multiple vehicle types. According to various implementations, the vehicle management system can include functionality and aspects for receiving various information (e.g., sensor information from vehicle sensors, information from sources external to the vehicle, and/or the like) and for controlling the operation of a vehicle. The vehicle management system can be used for managing and/or controlling various types of vehicles including, for example autonomous vehicles, semiautonomous vehicles, unmanned vehicles, arial vehicles (e.g., unmanned aerial vehicles (“UAVs”), vertical take-off and landing (“VTOL”) aircraft, and/or the like), aquatic vehicles (e.g., submarines, ships, and/or the like), land vehicles (e.g., cars, offroad vehicles, and/or the like), other types of vehicles, and/or any combination of the foregoing.

According to various implementations, the modular nature of the vehicle management system can advantageously provide for the rapid development of control systems for new and/or various types of vehicles. For example, the vehicle management system can improve the ease of adapting control systems from one vehicle type to another vehicle type. According to various implementations, the vehicle management system can include a vehicle-specific board (also referred to as a vehicle carrier board) and a vehicle management board. As further described herein, the vehicle-specific board may be adapted to particular vehicles and/or vehicle types, and may provide, and/or provide connections needed to convey, sensor data and/or operational data to the vehicle management board. For example, the vehicle-specific board may provide vehicle-specific and/or vehicle-type-specific connections and/or interfaces to sensors, controllers, actuators, and/or the like, of the vehicle. The vehicle-specific board may further provide connection(s) and/or interface(s) to the vehicle management board. The vehicle management board may interface with the vehicle-specific board and may generate control data based on the sensor data and/or operational data, and may transmit the control data to the vehicle-specific board. The vehicle-specific board can communicate instructions to vehicle sensors, controllers, actuators, and/or the like, based on the control data.

### Example Aspects Related to Vehicle-Specific Boards

A vehicle-specific board can include components and connections that are specific to a particular vehicle. As can be appreciated, different vehicle types may have different components and/or power requirements. For example, a UAV may include one or more sensors that are not used by a submarine, and vice versa. Further, differing environmental conditions that different vehicle types may operate in may require differing connections between components. For example, a submarine may require connections that prevent water ingress under extreme pressures. The vehicle-specific board can include all the connections that are required to gather information from a particular vehicle and send control instructions to sensors, controllers, actuators, and/or the like on the vehicle.

A vehicle-specific board can receive sensor data from the vehicle. The sensor data can be information generated by one or more sensors located on the vehicle. Sensor data can include information gathered about the vehicle, such as vehicle position, vehicle location, the status of the vehicle and/or vehicle components, and/or other information collected about the vehicle. The sensor data can be collected by individual sensors and/or systems of sensors located on the vehicle. For example, the sensor data can include information from positioning, navigation, and timing (“PNT”) sensors, global positioning systems (“GPSs”), inertial navigation systems (“INSs”), gyroscopes, accelerometers, altimeters, and/or thermometers located on the vehicle, and/or the like. The sensor data can vary depending on the vehicle type and/or the sensors on a particular vehicle. For example, sensor data from collected from a submarine may include data from a sonar system that may not be installed on a UAV.

A vehicle-specific board can further receive operational data from the vehicle. The operational data can be information generated by one or more computing devices, such as computing devices located on the vehicle and/or computing devices external to the vehicle and transmitted to the vehicle via a datalink 140. The operational data can include any instructions for the vehicle and/or instructions for vehicle components, such as mission payloads, navigation waypoints, and/or vehicle states, and/or the like. For example, the operational data can include GPS coordinates for a UAV to navigate to and instructions for one or more camera systems located on the UAV.

A vehicle-specific board can include power converting circuitry. The power converting circuitry can include electrical components, such AC-DC power converters, DC-AC power converters, and/or DC-DC power converters that can convert power received from the vehicle to an appropriate type from the vehicle-specific board and/or the vehicle management board. For example, the power conversion circuitry can convert relatively high voltage power received from a vehicle to the power specifications of the vehicle-specific board and/or the vehicle management board.

Each vehicle-specific board may include a connection interface. The connection interface may provide physical coupling with a vehicle management board. For example, the connection interface can include fasteners, such as screws, anchors, clips, and the like that can be used to physically couple and decouple the vehicle management board and the vehicle-specific board. The connection interface may provide electrical coupling with a vehicle management board. For example, the connection interface can include electrical connectors, such as pins, jacks, and the like that can be used to transmit electrical signals when coupled. The vehicle-specific board may provide and/or convey sensor data, operational data, and electrical power to a vehicle management board via the connection interface. The vehicle-specific board may receive control data from a vehicle management board via the connection interface.

The connection interface can have the same physical characteristics and/or footprint on the vehicle-specific boards, regardless of vehicle type. For example, the physical dimensions of a vehicle-specific board corresponding to a VTOL may differ from the physical dimensions of a vehicle-specific board corresponding to an offroad land vehicle. In this example, both the vehicle-specific board corresponding to the VTOL and the vehicle-specific board corresponding to the offroad land vehicle can have a connection interface for connecting to the vehicle management board with the same physical characteristics and/or footprint positioned on the vehicle-specific boards. As such, a vehicle management board may be useable with vehicle-specific boards for any of multiple types of vehicles.

### Example Aspects Related to the Vehicle Management Board

The vehicle management board can include various components that are universal to the vehicle management system, regardless of the particular vehicle the vehicle management system is installed in. The vehicle management board can include various processors, field programmable gate arrays (“FPGAs”), computing memory, power converters, and the like. The vehicle management board can include a connection interface for connecting with the vehicle-specific boards. The connection interface can include various electrical and physical connectors. The connection interface can correspond to a connection interface on the vehicle-specific boards. For example, the connection interface on the vehicle management board can include corresponding physical and electrical coupling components to the physical and electrical coupling components of the connection interface on the vehicle-specific board.

The vehicle management board can generate control data for a vehicle based on information received from or through the vehicle-specific board, such as the sensor and operational data. The control data can include the information needed to control, operate, and/or manage the vehicle. For example, the control data can include instruction, control signals, and/or the like to control various actuators, engines, motors, drive trains, gear boxes, transmissions, control surfaces, servos, power generation systems, power distribution systems, and/or the like, positioned on the vehicle. The control data can be utilized by one or more control systems on the vehicle, such as electronic engine control units (“ECUs”), electric speed controllers (“ESCs”), digital electronic engine controllers (“DEECs”), and full authority digital engine control (“FADEC”) systems, and/or the like. The vehicle management board can generate the control data based in part on sensor data and/or operational data received from the vehicle-specific board.

The vehicle management board may generate the control data based on mission critical information. Mission critical information can include a set of instructions for the vehicle to accomplish an overall task. For example, mission critical information can include locations for the vehicle to travel to, targets for targeting and/or surveillance systems on the vehicle, timing information, and the like. In various implementations, the operational data conveyed to the vehicle management board can include all or a portion of the mission critical information. In various implementations, all or a portion of the mission critical information can be stored in memory on the vehicle management board.

The vehicle management board may also generate the control data based on safety critical information. Safety critical information can include and/or be based on safety critical tests for the control data. The safety critical tests can be applied while the vehicle management board generates the control data. For instance, while generating the control data, the system can determine, based on the sensor data and/or operational data, that performing one or more tasks indicated by the mission critical information will fail a safety critical test. The safety critical tests can include any override condition for the vehicle. Override conditions can include determinations regarding vehicle safety such as a determination that the task will result in vehicle failure (e.g., a vehicle crash, critical failure of vehicle engine systems, and/or the like). Override conditions can include determinations regarding safety of other subjects, such as vehicle passengers or persons outside the vehicle. In various implementations, the operational data and/or sensor data conveyed to the vehicle management board can include all or a portion of the safety critical information. In various implementations, all or a portion of the safety critical information can be stored in memory on the vehicle management board.

As such, in various implementations, the vehicle management board can generate the control data based on mission critical information, safety critical information, sensor data, operational data, and/or any combination thereof.

Various combinations of the above and below recited features, implementations, and aspects are also disclosed and contemplated by the present disclosure.

In various implementations, systems and/or computer systems are disclosed that comprise one or more computer-readable storage mediums comprising, configured to store, and/or storing program instructions, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums, and/or one or more computer-readable storage mediums, are disclosed, wherein the computer-readable storage medium(s) comprises, is configured to store, and/or stores program instructions, the program instructions executable by one or more processors to cause the one or more processors to perform operations comprising one or more aspects of the above- and/or below-described implementations (including one or more aspects of the appended claims).

### Example Vehicle Management System

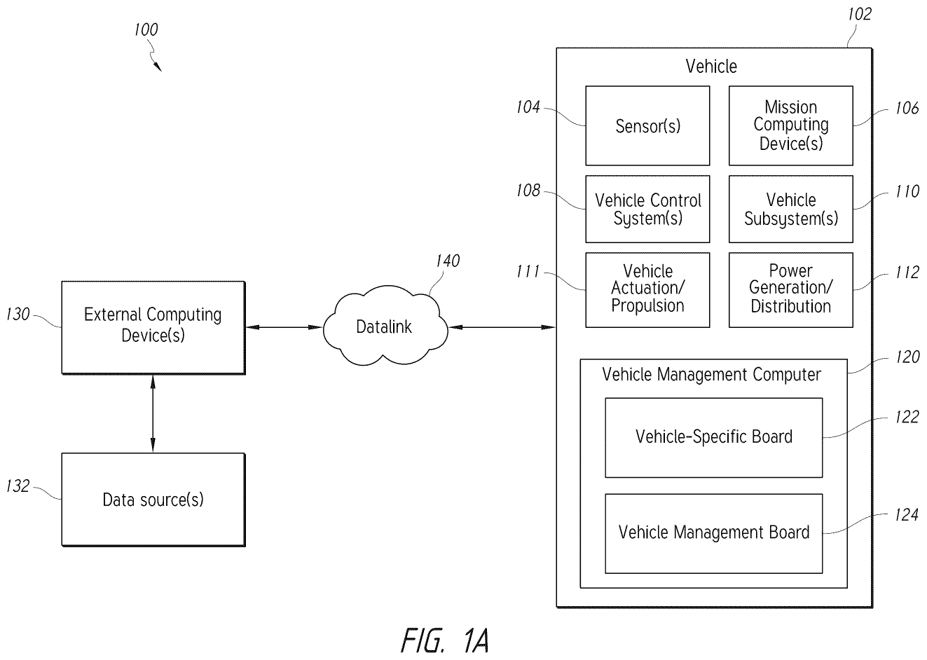

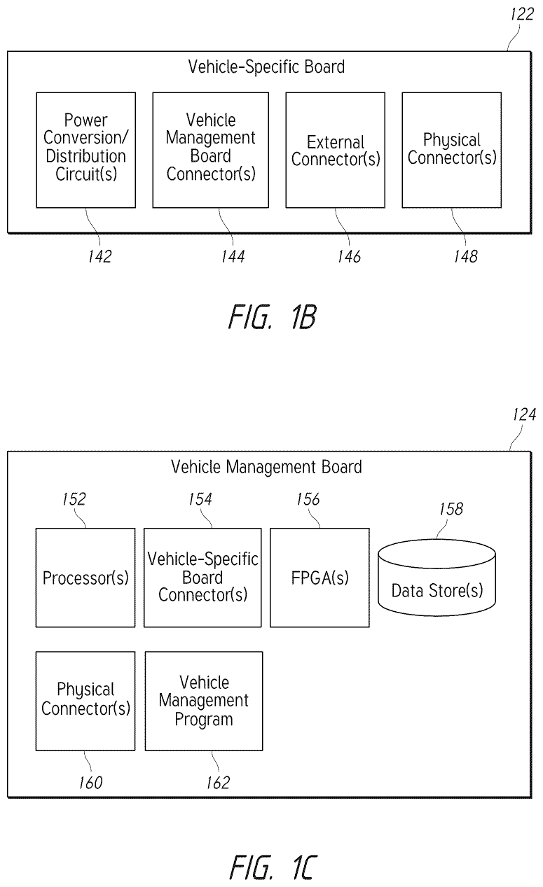

FIG. 1A illustrates a block diagram of an example computing environment 100 of the vehicle management system, according to various implementations. The example computing environment 100 may include a vehicle 102, one or more external computing devices 130, one or more data sources 132, and one or more networks and/or datalinks 140 (herein referred to as datalink 140 and/or network 140). The vehicle 102 may be connected to the external computing devices 130 via the network 140. The vehicle may include one or more sensors 104, one or more mission computing devices 106, one or more vehicle control systems 108, one or more vehicle subsystems 110, a vehicle actuation/propulsion system 111, a power generation/distribution system 112, and a vehicle management computer 120. The vehicle management computer 120 can include a vehicle-specific board 122 and a vehicle management board 124. As described herein, the vehicle management system may include, for example, and according to various implementations, one or more of the components depicted in the example computing environment 100 of FIG. 1A.

### Example Aspects Related to Vehicle 102

Vehicle 102 can be any vehicle controlled by the vehicle management system. For example, vehicle 102 can be any vehicle of various types of vehicles including, for example an autonomous vehicle, a semiautonomous vehicle, an unmanned vehicles, an arial vehicle (e.g., an unmanned aerial vehicle (“UAV”), vertical take-off and landing (“VTOL”) aircraft, and/or the like), an aquatic vehicle (e.g., a submarine, ship, and/or the like), a land vehicle (e.g., a car, offroad vehicle, and/or the like), other vehicle, and/or any combination of the foregoing.

In various implementations, the vehicle 102 may include one or more digital data interfaces to send and/or receive digital data via a wired and/or a wireless link. For example, vehicle 102 may include one or more wireless transceivers, one or more antennas, and/or one or more electronic systems (e.g., front end modules, antenna switch modules, digital signal processors, power amplifier modules, and/or the like) that support communication over one or more communication links and/or networks, such as network 140. In some examples, each transceiver may be configured to receive and/or transmit different types of signals based on different wireless standards via the antenna (e.g., an antenna chip). Some transceivers may support communication by using a low power wide area network (“LPWAN”) communication standard. In some examples, one or more transceivers may support communication with wide area networks (“WANs”) such as a cellular network transceiver that enables 3G, 4G, 4G-LTE, or 5G. Further, one or more transceivers may support communication via a Narrowband Long-Term Evolution (“NB-LTE”), a Narrowband Internet-of-Things (“NB-IoT”), or a Long-Term Evolution Machine Type Communication (“LTE-MTC”) communication connection with the wireless wide area network. In some cases, one or more transceivers may support Wi-Fi communication. In some cases, one or more transceivers may support data communication via a Bluetooth and/or Bluetooth Low Energy (“BLE”) standard. In some examples, one or more transceivers may be capable of down-converting and/or up-converting a baseband or data signal from and/or to a wireless carrier signal. In some examples, the vehicle 102 may wirelessly exchange data between other components, such as other portions of the system or another system, a mobile device (e.g., smartphone, a laptop, and/or the like), a Wi-Fi network, WLAN, a wireless router, a cellular tower, a Bluetooth device, and/or the like. The antenna may be capable of sending and receiving various types of wireless signals including, but not limited to, Bluetooth, LTE, or 3G.

### Example Aspects Related to Sensors 104

In various implementations, the vehicle 102 can include one or more sensors 104 positioned on the vehicle 102. The sensors 104 can collect information about the vehicle 102 (e.g., vehicle position, vehicle location, one or more vehicle and/or component status updates and/or the like). The sensors 104 can include one or more individual sensors and/or one or more systems of sensors. For example, the sensors 104 can include global positioning systems (“GPSs”), inertial navigation systems (“INSs”), gyroscopes, accelerometers, altimeters, thermometers, and/or the like. In various implementations, the sensors 104 can vary depending on a type of the vehicle 102. For example, all or a portion of the sensors 104 located on a VTOL may differ from the sensors 104 located on a UAV.

In various implementations, the sensors 104 can include one or more components with positioning, navigation, and timing (“PNT”) capabilities. Such PNT components may include, for example, global navigation satellite system capabilities (e.g., global positioning system (“GPS”) capabilities), among other PNT functions as described herein. The one or more PNT components may further provide orientation information, altitude information, angle/tilt information, and/or the like. The PNT capabilities may also be referred to herein as “positioning capabilities”, and the one or more PNT components may also be referred to herein as “positioning components”, and/or the like. The PNT capabilities may be used, for example, in object location determinations and/or tracking, as described herein, because such functionality may be dependent on the position, orientation, tilt, and/or the like, of a corresponding vehicle control system 108.

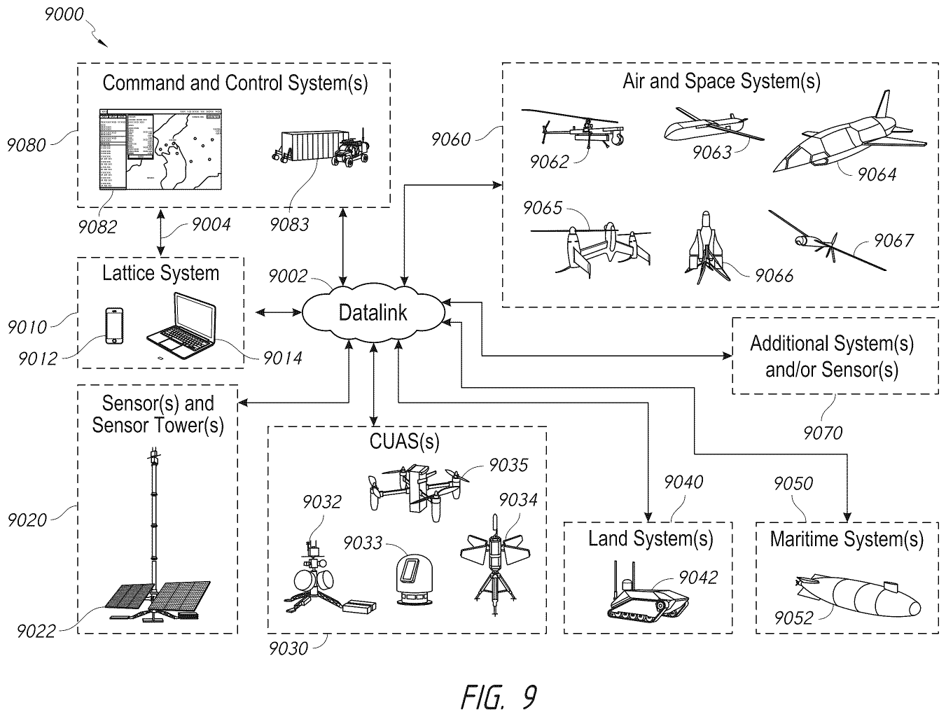

The sensors 104 may include various sensor and monitoring equipment. For example, non-limiting examples of sensors 104 may include: sensors/monitors (e.g., temperature, positioning/location, PNT, a direction finder, altitude, angle/tilt, levels, wind, vibration, power, pressure, and/or the like); cameras (e.g., video, audio, position, motion, heat, and/or the like); antennas (e.g., long range, short range, and/or the like); radar devices; light detection and ranging (“LIDAR”) devices; sound navigation and ranging (“SONAR”); mobile systems or sensors (e.g., a sensor on a vehicle or an aerial system); stationary systems or sensors (e.g., a sensor on a tower station); other types of systems or sensors; and/or any combination of the foregoing. Additional examples of sensors 104 are described in, for example: U.S. Patent Publication No. 2020/0167059, published May 28, 2020, and titled “Interactive Virtual Interface” (the '059 Publication), the entire disclosure of which is hereby made part of this specification as if set forth fully herein and incorporated by reference for all purposes, for all that it contains. Additional examples of systems or sensors that may be included in an operational environment of the system, and which may provide information, or receive information, as described herein, are described in: U.S. Patent Publication No. 2020/0363824, published Nov. 19, 2020, and titled “Counter Drone System” (the '824 Publication), the entire disclosure of which is hereby made part of this specification as if set forth fully herein and incorporated by reference for all purposes, for all that it contains. Additional examples and/or aspects related the operational environment of the system are described herein in reference to, for example, FIG. 9.

Information collected about the vehicle 102 by the sensors 104 can be communicated to the vehicle management computer 120 as sensor data. For example, the sensors 104 can be electrically coupled to the vehicle management computer 120 (e.g., through the vehicle-specific board 122) such that sensor data is collected by the vehicle management computer 120. In various implementations, the sensors are coupled to the mission computing devices 106. In these implementations, some of or all the sensor data may be communicated to the vehicle management computer 120 via the mission computing devices 106. The mission computing devices 106 may preprocess some of or all the sensor data prior to communicating the sensor data to the vehicle management computer 120.

### Example Aspects Related to Mission Computing Devices 106

The mission computing devices 106 can generate all or a portion of operational data for the vehicle 102. The operational data can include any instructions for the vehicle and/or instructions for vehicle components, such as mission payloads, navigation waypoints, and vehicle states, and/or the like. For example, the operational data can include GPS coordinates for a UAV to navigate to and instructions for one or more camera systems located on the UAV. In various implementations, the mission computing devices 106 can receive all or a portion of the operational data from the external computing devices 130 via the network 140. The mission computing devices 106 can communicate the operational data to the vehicle management computer 120. In various implementations, all of the operational data can be communicated to the vehicle management computer 120 from the external computing devices 130.

In various implementations, the mission computing devices 106 may process data received from the external computing devices 130 and/or from one or more data sources 132 to generate the operational data for the vehicle 102. For example, the mission computing device 106 may receive high level instructions (e.g., a GPS coordinate for the vehicle to travel to) and generate operational data comprising sub-instructions to accomplish the high level instruction that may be communicated to the vehicle management computer 120. In various implementations, the mission computing devices 106 may communicate data received from the external computing devices 130 and/or from the data sources 132 to the vehicle management computer 120 as operational data without processing the data. In various implementations, the mission computing devices 106 may process a portion of data received from the external computing devices 130 and/or from the data sources 132 and communicate the processed portion of data and unprocessed portion of data to the vehicle management computer 120 as operational data.

In various implementations, the mission computing device 106 may be coupled to one or more sensors 104. In these implementations, the mission computing devices may preprocess some information received from the sensors 104 to form a portion of or all the sensor data communicated to a vehicle management computer 120.

In various implementations, the mission computing device 106 may include one or more of hardware components and one or more software components. For example, the software components may be implemented by one or more processing modules (e.g., may comprise software instructions stored in the memory, and executed by the processor(s), GPU(s), signal transceiver(s), components thereof, and/or the like).

In various implementations, the one or more of the software components may comprise executable software instructions, modules, engines, and/or the like, that may communicate with one another to share computer resources to execute various tasks in conjunction with a specific functionality such as: generating operational data, receiving operational data from the external computing devices 130, and/or transmitting operational data to the vehicle management computer 120.

### Example Aspects Related to Vehicle Actuation/Propulsion Systems 111

The vehicle actuation/propulsion system 111 can include one or more actuators to control the vehicle 102 and/or vehicle components. For example, the actuation/propulsion system 111 can include steering systems, flaps (e.g., stabilizers, elevons, ailerons, rudders, elevators, and/or the like), rudders, and/or equipment deployment systems (e.g., vehicle landing systems, parachute deployment systems, cargo or munitions deployment systems), and/or the like. The vehicle actuation/propulsion system 111 can include one or more propulsion systems to control the vehicle 102 propulsion. For example, the actuation/propulsion system 111 can include engines, motors, drive trains, gear boxes, transmissions, control surfaces, servos, turbines, and/or propellers, and/or the like.

In various implementations, the actuators and/or propulsion systems of the vehicle actuation/propulsion system 111 can be activated and/or controlled based on control instructions and/or signals received by the vehicle actuation/propulsion system 111. For example, the vehicle actuation/propulsion system 111 can receive control instructions and/or signals from the vehicle control systems 108 to control the actuators and/or propulsions systems. In various implementations, the vehicle actuation/propulsion system 111 can receive control instructions and/or signals from other vehicle components, such as from the vehicle management computer 120 (e.g., as control data).

### Example Aspects Related to Power Generation/Distribution System 112

The power generation/distribution system 112 can generate and distribute electrical power to the vehicle 102. The power generation/distribution system 112 may include one or more power generators, one or more energy storage devices, fuel storage and distribution systems, power distribution circuitry, and/or the like to facilitate the generation and distribution of electrical power to the vehicle. In various implementations, the power generation/distribution system 112 can generate power by using other systems of the vehicle 102. For example, the power generation/distribution system may include one or more alternators that generate power from motors in the vehicle actuation/propulsion system 111.

In various implementations, power generators, energy storage devices, fuel storage and distributions systems, power distribution circuitry, and/or the like can be activated and/or controlled based on control instructions and/or signals received by the power generation/distribution system 112. For example, the power generation/distribution system 112 can receive control instructions and/or signals from the vehicle control systems 108 to control the various components of the power generation/distribution system 112. In various implementations, the power generation/distribution system 112 can receive control instructions and/or signals from other vehicle components, such as from the vehicle management computer 120 (e.g., as control data).

In various implementations, the vehicle 102 can collect information associated with the power generation/distribution system 112. For example, the power generation/distribution system 112 may be integrated with one or more of the sensors 104, tracked by the mission computing devices 106, and/or the like to collect information associated with the power generation/distribution system 112. The information associated with the power generation/distribution system 112 may include, for example, available power, fuel levels, current power output, and/or the like. The information associated with the power generation/distribution system 112 may be conveyed to the vehicle management computer 120 (e.g., as sensor data and/or operational data).

### Example Aspects Related to Vehicle Subsystems 110

The vehicle subsystems 110 can include any vehicle component used in vehicle 102 operation. In various implementations, all or a portion of the vehicle subsystems 110 may depend on a type of the vehicle 102. For example, an aerial type vehicle may include vehicle subsystems 110 for takeoff and/or landing. As another example, a vehicle configured to carry cargo and/or passengers may include vehicle subsystems 110 to monitor cargo and/or passenger status, such a life support systems. In various implementations, all or a portion of the vehicle subsystems 110 may be in more than one vehicle 102 type and/or in all vehicle 102 types.

### Example Aspects Related to Vehicle Control Systems 108

The vehicle control systems 108 can control the vehicle 102 based on control data received by the vehicle management computer 120. For example, the vehicle control systems 108 can control the vehicle subsystems 110, vehicle actuation/propulsion system 111 power generation/distribution system 112, and/or other components on the vehicle based on the control data. The vehicle control systems 108 can include one or more control systems, such as electronic engine control units (“ECUs”), electric speed controllers (“ESCs”), digital electronic engine controllers (“DEECs”), and full authority digital engine control (“FADEC”) systems, and/or the like.

According to various implementations, vehicle control systems 108 functions, such as FADEC functions, can include one or more of the following control aspects: starter/generator control, main fuel pump/solenoid control, pilot fuel pump/solenoid control, ESTOP input (cuts power to engine and fuel pumps), servo controls, “Pulse Width Modulation” (“PWM”) outputs for, e.g., thrust vector controls (“TVCs”) and rudders, water injection control for air inlet system cooling, glow plug control, flame detector bias and serial communications, differential and absolute pressure transducers, engine gas temperature monitor, and/or starter/generator power pass through, and/or the like.

In various implementations, the vehicle control systems 108 can receive control data from the vehicle management computer 120. In such implementations, the vehicle control systems 108 may generate control instructions and/or signals based on the control data, and/or convey the control data directly to control the vehicle subsystems 110, vehicle actuation/propulsion system 111 power generation/distribution system 112. For example, in some instances, the control data, or a portion thereof, may include information configured to control a vehicle component, such as the vehicle actuation/propulsion system 111. In this example, the control data may be conveyed directly to the vehicle actuation/propulsion system 111. In other instances, the control data, or a portion thereof, may be further processed by the vehicle control systems 108 before the control instructions and/or signals are transmitted to a vehicle component. For example, the vehicle control systems 108 may receive control data and generate a PWM signal to control a vehicle component.

### Example Aspects Related to Vehicle Management Computer 120

The vehicle management computer 120 can receive operational data from the mission computing devices 106 and/or the external computing devices 130 and/or sensor data from the sensors 104 and generate control data. The vehicle management computer 120 can communicate control data to the vehicle control systems 108, the vehicle subsystems 110, the vehicle actuation/propulsion system 111, and/or the power generation/distribution system 112. The vehicle management computer 120 can include a vehicle-specific board 122 and a vehicle management board 124. The vehicle-specific board 122 is further described in reference to FIG. 1B. The vehicle management computer 120 is further described in reference to FIG. 1C.

In various implementations, the vehicle management computer 120 may generate the control data based on mission critical information. Mission critical information can include a set of instructions for the vehicle to accomplish an overall task. For example, mission critical information can include locations for the vehicle to travel to, targets for targeting and/or surveillance systems on the vehicle, timing information, and/or the like. In various implementations, the operational data conveyed to the vehicle management computer 120 can include all or a portion of the mission critical information. In various implementations, all or a portion of the mission critical information can be stored in memory on the vehicle management computer 120.

In various implementations, the vehicle management computer 120 may generate the control data based on safety critical information. Safety critical information can include and/or be based on safety critical tests for the control data. The safety critical tests can be applied while the vehicle management computer 120 generates the control data. For instance, while generating the control data, the vehicle management computer 120 can determine, based on the sensor data and/or operational data, that performing one or more tasks indicated by the mission critical information will fail a safety critical test. The safety critical tests can include any override condition for the vehicle. Override conditions can include determinations regarding vehicle safety such as a determination that the task will result in vehicle failure (e.g., a vehicle crash, critical failure of vehicle engine systems, and/or the like). Override conditions can include determinations regarding safety of other subjects, such as vehicle passengers and/or persons outside the vehicle. In various implementations, the operational data and/or sensor data conveyed to the vehicle management computer 120 can include all or a portion of the safety critical information. In various implementations, all or a portion of the safety critical information can be stored in memory on the vehicle management computer 120.

As such, in various implementations, the vehicle management computer 120 can generate the control data based on mission critical information, safety critical information, sensor data, operational data, or any combination thereof.

### Example Aspects Related to External Computing Devices 130

The external computing devices 130 can generate all or a portion of operational data for the vehicle 102. As previously described, the operational data can include any instructions for the vehicle and/or instructions for vehicle components, such as mission payloads, navigation waypoints, and vehicle states, and/or the like. For example, the operational data can include GPS coordinates for a UAV to navigate to and instructions for one or more camera systems located on the UAV. In various implementations, the external computing devices 130 can communicate all or a portion of the operational data to the mission computing devices 106 via the network 140. In various implementations, the external computing devices 130 can communicate all or a portion of the operational data directly to the vehicle management computer 120.

In various implementations, the external computing devices 130 may process data received from the vehicle 102 and/or one or more data sources 132 to generate all or a portion of the operational data for the vehicle 102. For example, the external computing devices 130 may receive data pertaining to one or more of: artificial intelligence/machine learning (“AI/ML”) models, application programming interface (“API”) information, captured camera and/or sensor data (e.g., of a detected object), flight track, instructions, automated protocols, data related to maneuverability, sensor metrics (e.g., fuel and/or battery level, altitude, positioning, and/or the like), encryption procedures, and/or the like, from the vehicle 102 and/or from data sources 132 and generate operational data.

In various implementations, the external computing devices 130 can generate high level instructions (e.g., a GPS coordinate for the vehicle to travel to) and communicate the high level instructions to the mission computing devices 106 and/or vehicle management computer 120.

In various implementations, the external computing devices 130 may include one or more of hardware components and one or more software components. For example, the software components may be implemented by one or more processing modules (e.g., may comprise software instructions stored in the memory, and executed by the processor(s), GPU(s), signal transceiver(s), components thereof, and/or the like).

In various implementations, the one or more of the software components may comprise executable software instructions, modules, engines, and/or the like, that may communicate with one another to share computer resources to execute various tasks in conjunction with a specific functionality such as: generating operational data, communicating operational data to the mission computing devices 106, and/or transmitting operational data to the vehicle management computer 120.

### Example Aspects Related to Data Sources 132 and Network 140

The data sources 132 may comprise any system, computer-readable storage medium, and/or device (or collection of systems, data storage mediums, and/or devices). Examples of data sources 132 include, but are not limited to, optical disks (e.g., CD-ROM, DVD-ROM, and/or the like), magnetic disks (e.g., hard disks, floppy disks, and/or the like), memory circuits (e.g., solid-state drives, random-access memory (“RAM”), and/or the like), and/or the like. Another example of data sources 132 are hosted storage environments that includes a collection of physical data storage devices that may be remotely accessible and may be rapidly provisioned as needed (commonly referred to as “cloud” storage). The data sources 132 can include one or more of volatile and/or non-volatile memory.

In various implementations, data sources 132 can include data pertaining to one or more of: artificial intelligence/machine learning (“AI/ML”) models, application programming interface (“API”) information, captured camera and/or sensor data (e.g., of a detected object), flight track, instructions, automated protocols, data related to maneuverability (if applicable), sensor metrics (e.g., fuel and/or battery level, altitude, positioning, and/or the like), encryption procedures, and/or the like, for example.

In various implementations, an API may be utilized by which communications may be accomplished with a corresponding external computing device 130, mission computing device 106, and/or vehicle management computer 120. For example, data collected and/or generated by vehicle management computer 120 can be sent to data sources 132 to be combined with other data collected (e.g., from other systems and/or sensors, and the like) and stored for later transmission to any system and/or vehicle 102 on the network 140 and/or outside of the network 140 (e.g., via the internet using an API).

While the data sources 132 are illustrated as separate from vehicle 102 in FIG. 1A, in various implementations, all or a portion of the data sources 132 may be integrated with the vehicle 102. For example, all or a portion of the data sources 132 may correspond to the data stores 158 of FIG. 1C.

The network 140 can be any wired network, wireless network, or combination thereof. For example, the network 140 may be a personal area network, local area network, wide area network, over-the-air broadcast network (e.g., for radio and/or television), cable network, satellite network, cellular telephone network, or combination thereof. As a further example, the network 140 may be a publicly accessible network of linked networks, possibly operated by various distinct parties, such as the Internet. In various implementations, the network 140 may be a private or semi-private network, such as a corporate or university intranet. The network 140 may include one or more wireless networks, such as a Global System for Mobile Communications (“GSM”) network, a Code Division Multiple Access (“CDMA”) network, a Long Term Evolution (“LTE”) network, C-band, mmWave, sub-6 GHZ, or any other type of wireless network. The network 140 can use protocols and components for communicating via the Internet or any of the other aforementioned types of networks. For example, the protocols used by the network 140 may include Hypertext Transfer Protocol (“HTTP”), HTTP Secure (“HTTPS”), Message Queue Telemetry Transport (“MQTT”), Constrained Application Protocol (“CoAP”), and the like. Protocols and components for communicating via the Internet or any of the other aforementioned types of communication networks are well known to those skilled in the art and, thus, are not described in more detail herein.

In various implementations, the network 140 can represent a network that may be local to a particular organization, e.g., a private or semi-private network, such as an intranet. In various implementations, devices (e.g., the flight system, or a control station system, or the like) may communicate via the network 140 without traversing an external network, such as the Internet. In various implementations, devices in communication via the network 140 may be walled off from accessing the Internet, e.g., the network 140 may not be in communication with the Internet. Accordingly, e.g., the user device(s) may communicate via the network 140 without using the Internet. Similarly, devices may communicate via dedicated communications links, and/or any combination of networks, communications links, and/or the like. Thus, even if a network or the Internet is down, communication and functions via direct communications (and/or via the network 140) are still available.

In various implementations, the network 140 and/or various other aspects of the vehicle management system, the computing environment 100, and/or the operational environment, may incorporate “mesh” type communications among components (e.g., a communications routing layer), and/or secure communications among components. The mesh, for example, provides functionality to transfer data between and among numerous devices/systems/sensors by using “pub/sub” mechanics, or published/subscribed mechanics. This allows the vehicle management system to function without having to have engineers resolve specific logistics of moving data between each individual device/system/sensor in the mesh network. An example of pub/sub mechanics includes a sensor tower that might want to tell a first vehicle 102 where it sees a target. The sensor tower might not have direct line of sight, or even a communication link, with the first vehicle 102. The first vehicle 102 might only be able to communicate (e.g., line of sight communication) with a second vehicle 102, which can communicate with a ground control station, which can communicate with the sensor tower (e.g., based on antenna links, signal strength, or the like). Examples of such mesh and/or secure communications are described in U.S. Patent Publication No. 2019/0380032, published Dec. 12, 2019, and titled “Lattice Mesh” (the '032 Publication), the entire disclosure of which is hereby made part of this specification as if set forth fully herein and incorporated by reference for all purposes, for all that it contains. Additional examples and/or aspects related the operational environment of the system are described herein in reference to, for example, FIG. 9.

In various implementations, pub/sub mechanics is an asynchronous and scalable messaging service that decouples services producing messages from services processing those messages. For example, pub/sub allows services to communicate asynchronously, with latencies on the order of 100 milliseconds. Also, for example, pub/sub can be used for streaming analytics and data integration pipelines to ingest and distribute data, and can be effective as a messaging-oriented middleware for service integration or as a queue to parallelize tasks. In various implementations, pub/sub enables creation of systems of event producers and consumers, called publishers and subscribers, where publishers communicate with subscribers asynchronously by broadcasting events, rather than by synchronous remote procedure calls (“RPCs”). For example, publishers send events to a pub/sub service, without regard to how or when these events are to be processed. Then, the pub/sub service delivers events to all the services that react to them. However, for example, in systems communicating through RPCs, publishers must wait for subscribers to receive the data. With sub/pub services, however, the asynchronous integration in pub/sub increases the flexibility and robustness of the overall system.

### Example Vehicle-Specific Board

FIG. 1B illustrates an example vehicle-specific board 122, according to various implementations. The vehicle-specific board 122 may include one or more power conversion/distribution circuits 142, one or more vehicle management board connectors 144, one or more external connectors 146, and one or more physical connectors 148.

In various implementations, the vehicle-specific board 122 can act as a conduit from a vehicle 102 to a vehicle management board 124 for sensor data, operational data, control data, power, physical structure, or any combination thereof. For instance, the vehicle-specific board 122 can receive sensor data and/or operational data from a vehicle 102 and convey the sensor data and/or operational data to a vehicle management board 124. The vehicle-specific board 122 can also receive control data from a vehicle management board 124 and convey the control data to the vehicle 102.

In various implementations, the vehicle-specific board 122 may have one or more aspects that are specific to a type of vehicle 102 the vehicle-specific board 122 is implemented in. For instance, the physical aspects of the vehicle-specific board 122 (e.g., the size, component layout, and/or the like of the vehicle-specific board 122), the power conversion/distribution circuits 142, the external connectors 146, and/or the physical connectors 148 each may have portions that are specific to the type of vehicle 102. Advantageously, a vehicle-specific board 122 may include the components to couple to the same vehicle management board 124 regardless of the type of vehicle 102 the vehicle-specific board 122 is implemented in. As such, the functionality of the vehicle management board 124 can be rapidly transferred and/or developed to new type of vehicle 102.

### Example Aspects Related to Power Conversion/Distribution Circuits 142

The power conversion/distribution circuits 142 can receive power from a vehicle 102, convert the power to meet the specifications of the vehicle-specific board 122, a vehicle management board 124, and/or other vehicle components (e.g., sensors 104), and distribute power to the vehicle management board 124 and/or other vehicle components. The power conversion/distribution circuits 142 can include power converting circuitry. The power converting circuitry can include electrical components, such AC-DC power converters, DC-AC power converters, and/or DC-DC power converters that can convert power received from the vehicle 102 to an appropriate power type (e.g., convert the power to AC power or DC power and/or convert the power from one current/voltage to another current/voltage) from the vehicle-specific board 122, the vehicle management board 124, and/or other vehicle components. For example, the power conversion circuitry can convert relatively high power received from a vehicle 102 to the power specifications of the vehicle-specific board 122 and/or the vehicle management board 124.

In various implementations, the power conversion/distribution circuits 142 may be specific and/or configurable to a type of vehicle 102 associated with the vehicle-specific board 122. For example, the power received by a vehicle-specific board 122 associated with a VTOL may be of a different type than the power received by a vehicle-specific board 122 associated with a submarine. In this example, the power conversion required by the conversion/distribution circuits 142 to meet the specifications of the vehicle management board 124 may differ (e.g., the voltage may be different, one may have an alternating current while the other has a direct current, and/or the like.). In various implementations, the power conversion/distribution circuits 142 may be automatically configured. For example, by using one or more sensors to detect a power type received from the vehicle 102 and/or the specifications of the vehicle management board 124. In other implementations, the power conversion/distribution circuits 142 may be manufactured to operated on a specific vehicle 102.

In various implementations, some of or all the power conversion circuitry for the power conversion/distribution circuits 142 may be implemented by circuits separated from the vehicle-specific board 122. For example, some of or all the power conversion circuitry may be implemented by circuits on the vehicle management board 124.

The power conversion/distribution circuits 142 can include conductors and connectors to receive power from the vehicle 102, deliver power to power conversion circuitry, and deliver power to the vehicle management board 124. For example, the power conversion/distribution circuits 142 can include wires, printed circuit boards (“PCBs”), pins, plugs, and/or the like. In various implementations, the conductors and connectors may be integrated with other components of the vehicle specific board, such as in the vehicle management board connectors 144, the external connectors 146, and/or the physical connectors 148.

### Example Aspects Related to External Connectors 146

The external connectors 146 can include electrical connections and/or couplings to the vehicle 102, such as electrical couplings to sensors 104, mission computing devices 106, vehicle control systems 108, vehicle subsystems 110, the vehicle actuation/propulsion system 111, and/or the power generation/distribution system 112. The external connectors 146 may include electrical connectors that are specific to a particular vehicle 102. As can be appreciated, different vehicle types may have different components. For example, a UAV may include one or more sensors 104 that are not used by a submarine, and vice versa. Further, differing environmental conditions that different vehicle types operate in may require differing couplings between components. For example, a submarine may require couplings that prevent water ingress under extreme pressures. The external connectors 146 may include, for example, controller area network flexible data-rate (“CANFD”) bus connectors, RS232 connectors, RS422 connectors, RS485 connectors, ethernet connectors, and/or input/output (“I/O”) connectors, and/or the like.

The external connectors 146 can include electrical connections and/or couplings to receive sensor data from a vehicle 102, such as from sensors 104 and/or from the mission computing devices 106. The sensor data can include information gathered about the vehicle 102, such as vehicle position, vehicle location, the status of the vehicle and/or vehicle components, or other information collected about the vehicle. The sensor data can vary depending on the vehicle type and/or the sensors 104 on a particular vehicle. For example, sensor data collected from a submarine may include data from a sonar system that may not be installed on a UAV.

The external connectors 146 can include electrical connections and/or couplings to receive operational data from a vehicle 102, such as from the mission computing devices 106, and/or from an external system, such as from external computing devices 130. The operational data can be information generated by the mission computing devices 106 and/or external computing devices 130 and transmitted to the vehicle 102 via a network 140. The operational data can include any instructions for the vehicle 102 and/or instructions for vehicle components, such as mission payloads, navigation waypoints, and vehicle states, and/or the like. For example, the operational data can include GPS coordinates for a UAV to navigate to and instructions for one or more camera systems located on the UAV.

The external connectors 146 can include electrical connections t and/or couplings o receive power from the vehicle 102, such as couplings to the power generation/distribution system 112. As described above, the power can be converted and distributed by the power conversion/distribution circuits 142. The external connectors 146 can include electrical couplings to distribute power to the vehicle 102 and/or to other components of the vehicle 102. For example, one or more sensors 104 may receive power from the vehicle-specific board 122 via the external connectors 146 in lieu of, or in addition to, the power generation/distribution system 112.

The external connectors 146 can include electrical connections and/or couplings to communicate control (e.g., control data) to a vehicle 102, such as couplings to the vehicle control systems 108, vehicle subsystems 110, vehicle actuation/propulsion system 111, and/or power generation/distribution system 112. The control data can include the information needed to control, operate, and/or manage the vehicle 102.

### Example Aspects Related to Vehicle Management Board Connectors 144

The vehicle management board connectors 144 can include electrical connections and/or couplings to a vehicle management board 124. The vehicle management board connectors 144 may be agnostic to the type of vehicle 102 the vehicle-specific board 122 is implemented in. For instance, in various implementations the vehicle management board connectors 144 may have the same or similar physical characteristics and/or footprint, connectors, pins, jacks, and/or the like on a vehicle-specific board 122 associated with a VTOL as are on a vehicle-specific board associated with an offroad land vehicle.

The vehicle management board connectors 144 can include electrical connectors and/or couplings, such as pins, jacks, and the like that can be used to transmit electrical signals when coupled. The vehicle management board connectors 144 may include, for example, controller area network flexible data-rate (“CANFD”) bus connectors, RS232 connectors, RS422 connectors, RS485 connectors, ethernet connectors, and input/output (“I/O”) connectors, and/or the like. The vehicle-specific board 122 may provide and/or convey sensor data, operational data, and electrical power to a vehicle management board via the vehicle management board connectors 144. The vehicle-specific board 122 may receive control data from a vehicle management board 124 via vehicle management board connectors 144.

The vehicle management board connectors 144 can include electrical connections and/or couplings to convey sensor data to a vehicle management board 124, such as couplings the one or more vehicle-specific board connectors 154 of FIG. 1C. The sensor data can be the same sensor data received by vehicle management board via the external connectors 146. For example, the vehicle-specific board 122 may act as a passive conduit for the sensor data from the vehicle 102 to the vehicle management board 124. In various implementations, the sensor data received at the external connectors 146 may undergo transformation prior to the vehicle management board connectors 144 providing the sensor data to the vehicle management board 124 via the vehicle management board connectors 144. For example, the sensor data may be aggregated, filtered, separated into channels, and/or the like.

The vehicle management board connectors 144 can include electrical connections and/or couplings to convey operational data to a vehicle management board 124, such as couplings the one or more vehicle-specific board connectors 154 as described in reference to FIG. 1C. The operational data can be the same sensor data received by vehicle management board via the external connectors 146. For example, the vehicle-specific board 122 may act as a passive conduit for the operational data from the vehicle 102 to the vehicle management board 124. In various implementations, the operational data received at the external connectors 146 may undergo transformation prior to the vehicle management board connectors 144 providing the operational data to the vehicle management board 124 via the vehicle management board connectors 144. For example, the operational data may be aggregated, filtered, separated into channels, and/or the like.

The vehicle management board connectors 144 can include electrical connections and/or couplings to provide power from the power conversion/distribution circuits 142, such as coupling via the one or more vehicle-specific board connectors 154 of FIG. 1C. As discussed above, the power provided by the vehicle management board connectors 144 can be of a power type to meet the specifications of the vehicle management board 124.

The vehicle management board connectors 144 can include electrical connections and/or couplings to receive control data from the vehicle management board 124, such as coupling via the one or more vehicle-specific board connectors 154 of FIG. 1C. As described above, the control data can include the information needed to control, operate, and/or manage the vehicle 102.

### Example Aspects Related to Physical Connectors 148

The physical connectors 148 can include physical connections to physically couple the vehicle-specific board 122 to the vehicle 102 and to physically couple the vehicle-specific board 122 to a vehicle management board 124. The physical connectors 148 may include, for example, fasteners, such as screws, anchors, clips, and the like that can be used to physically couple and decouple the vehicle-specific board 122 to the vehicle management board 124 and/or the vehicle 102. The physical connectors 148 may be configured to couple to and decouple from physical couplings on the vehicle management board 124, such as the physical connectors 160 of FIG. 1C.

In various implementations, the physical connectors 148 can include a physical housing for the vehicle-specific board 122 and vehicle management board 124. The physical housing may provide protection from environmental conditions. The physical housing may include insulators, seals, electrical cages, and/or the like to maintain ideal operating conditions for the vehicle-specific board 122 and vehicle management board 124. The physical housing may be specific to a vehicle type. For example, the physical housing of a UAV may require a higher grade of electrical signal interference protection than a submarine.

### Example Vehicle Management Board

FIG. 1C illustrates an example vehicle management board 124, according to various implementations. The vehicle management board 124 may include one or more processors 152, one or more vehicle-specific board connectors 154, one of more FPGAs 156, one or more data stores 158, one or more physical connectors 160, and a vehicle management program 162.

In various implementations, the vehicle management board 124 can receive sensor data and operational data associated with the vehicle 102 via the vehicle-specific board 122. The vehicle management board 124 can generate control data for the vehicle 102 and communicate the control data to the vehicle 102 via the vehicle-specific board 122. Advantageously, the vehicle management board 124 can include various components that are independent of vehicle type. For example, the processors 152, vehicle-specific board connectors 154, FPGAs 156, data stores 158, physical connectors 160, and vehicle management program 162 described herein may be the same regardless of the type of vehicle 102 the vehicle management board 124 is installed in. As such, the vehicle management board 124 can be implemented in new vehicle types and/or transferred from one vehicle type to another.

### Example Aspects Related to Vehicle-Specific Board Connectors 154

The vehicle-specific board connectors 154 can include electrical connections and/or couplings to a vehicle-specific board 122. The vehicle-specific board connectors 154 may be agnostic to the type of vehicle 102 the vehicle-specific board 122 is implemented in. For instance, in various implementations the vehicle-specific board connectors 154 may have the same physical characteristics and/or footprint, connectors, pins, jacks, and/or the like to couple with corresponding connectors on a vehicle-specific board 122, regardless of if the vehicle 102 is a VTOL or an offroad land vehicle. The vehicle-specific board connectors 154 may include, for example, controller area network flexible data-rate (“CANFD”) bus connectors, RS232 connectors, RS422 connectors, RS485 connectors, ethernet connectors, and input/output (“I/O”) connectors, and/or the like.

The vehicle-specific board connectors 154 can include electrical connections and/or couplings to receive sensor data to from a vehicle-specific board 122. The vehicle-specific board connectors 154 can include electrical couplings to receive operational data to from a vehicle-specific board 122. The vehicle-specific board connectors 154 can include electrical couplings to receive power from a vehicle-specific board 122. For example, the vehicle-specific board connectors 154 can receive sensor data, operational data, and power from the vehicle management board connectors 144 of FIG. 1B.

In various implementations, the vehicle-specific board connectors 154 can include one or more dynamically configurable connection ports. For example, as described herein, one or more connections and/or couplings in the vehicle-specific board connectors 154 can be configured by FPGAs 156. The dynamically configurable connection ports may communicate at least a portion of the control data to the vehicle-specific board 122 and/or communicate at least a portion of the sensor data and/or operational data from the vehicle-specific board 122 to the vehicle management board 124. The dynamically configurable connection ports may be specific to a board type of the vehicle-specific board 122 and/or the vehicle 102.

### Example Aspects Related to Physical Connectors 160

The physical connectors 160 can include physical connections and/or couplings to physically couple the vehicle management board 124 the vehicle-specific board 122, thereby securing the vehicle management board 124 to the vehicle 102. The physical connectors 160 may include, for example, fasteners, such as screws, anchors, clips, and the like that can be used to physically couple and decouple the vehicle management board 124 to the vehicle-specific board 122. The physical connectors 160 may be configured to couple to and decouple from physical connections on the vehicle-specific board 122, such as the physical connectors 148 of FIG. 1B.

### Example Aspects Related to FPGAs 156

As described above, the vehicle management board 124 can include various components that are independent of vehicle type. However, aspects of the vehicle management board 124 and/or the vehicle management computer 120 the vehicle management board 124 is implemented in may benefit from reconfiguration and/or optimization. For example, one or more of the vehicle-specific board connectors 154 may be reconfigured (e.g., redesignated as an operational data pin rather than a sensor data pin) based on a type of the vehicle 102 and/or on a current operating state of the vehicle management board 124. As another example, one or more logic circuits of the vehicle management board 124 may be optimized based on a type of the vehicle 102 and/or on a current operating state of the vehicle management board 124.

The vehicle management board 124 may include one or more FPGAs 156 (which may comprise any reconfigurable and/or reprogrammable integrated circuit architecture, e.g., an FPGA architecture) that can be reconfigured based on instructions received from the vehicle management board 124. For example, the FPGAs 156 can be reconfigured based on instructions received from the processors 152 and/or the data stores 158. In various implementations, the instructions to reconfigure the FPGAs 156 can be based in part on operational data and/or other data received from the vehicle 102 via the vehicle-specific board 122. In various implementations, the instructions to reconfigure the FPGAs can be based on a type of the vehicle-specific board 122 and/or the vehicle 102 the vehicle-specific board 122 is implemented in. In various implementations, the FPGAs 156 can dynamically reconfigure one or more of the vehicle-specific board connectors 154, one or more logic circuits of the vehicle management board 124, and/or other component of the vehicle management board 124 based on the instructions.

### Example Aspects Related to Processors 152

The vehicle management board 124 can include one or more hardware components, such as the processors 152. The processors 152 can include one or more computer processors, GPUs, signal transceivers, components thereof, and/or the like. In various implementations, the processors 152 can include on or more systems on a chip (“SoC”) components integrated onto the vehicle management board 124. In various implementations, the processors 152 can include one or more separate processing boards and/or processing modules. In these implementations, the vehicle management board 124 can include one or more connectors to physically and electrically couple the vehicle management board 124 to the separate processing boards and/or processing modules. The processors 152 can execute one of more software programs stored in the data stores 158. For example, the processors 152 can execute the vehicle management program 162 described herein.

### Example Aspects Related to Data Stores 158

The data stores 158 may comprise any computer-readable storage medium and/or device (or collection of data storage mediums and/or devices). Examples of data stores 158 include, but are not limited to, random-access memory (“RAM”) magnetoresistive RAM (“MRAM”), quad serial peripheral interface (“QSPI”) flash memory, embedded multi-media card (“eMMC”), on-chip memory (“OCM”), solid-state drives, and/or the like.

In various implementations, the data stores 158 can store one or more programs for the processors 152 to execute, such as the vehicle management program 162. In various implementations, the data stores 158 can store information received from the vehicle 102, such as sensor data and/or operational data and information generated by the vehicle management board 124, such as control data.

In various implementations, the data stores 158 can store additional information. For example, the data stores 158 can store one or more parameters, vehicle states and/or tracking information, safety monitoring information (e.g., safety critical tests), and contingency management information.

### Example Aspects Related to Vehicle Management Program 162

The vehicle-specific board 122 can include a vehicle management program 162. In various implementations, the vehicle management program 162 may comprise executable software instructions, modules, engines, and/or the like, that may communicate with one another to share computer resources to execute various tasks in conjunction with a specific functionality such as: detecting and/or tracking a signal or object, identifying an object, generating and/or transmitting signals, training/sharing/applying an AI/ML model (e.g., to detect and/or track a signal or object, to determine movement patterns or a vehicle 102 travel plan, determine an action, and/or the like), determining location of the vehicle 102, determining location of a detected/tracked object, initiating an action, implementing one or more movements, reducing/increasing power output, and/or the like. In various implementations, functionality of the vehicle management program 162 can be shared by hardware components and/or other devices and systems, such as by FPGAs 156.

The vehicle management program 162 may generate control data for a vehicle 102 based on information received from or through the vehicle-specific board 122, such as the sensor data and operational data. The control data can include the information needed to control, operate, and/or manage the vehicle 102. For example, the control data can include instruction, control signals, and/or the like to control various actuators, engines, motors, drive trains, gear boxes, transmissions, control surfaces, servos, power generation systems, power distribution systems, and the like positioned on the vehicle 102. The control data can be utilized by one or more control systems on the vehicle, such as the vehicle control systems 108. The vehicle management program 162 can generate the control data based in part on sensor data and/or operational data received from the vehicle-specific board 122.

The vehicle management program 162 may generate the control data based on mission critical information. Mission critical information can include a set of instructions for the vehicle 102 to accomplish an overall task. For example, mission critical information can include locations for the vehicle 102 to travel to, targets for targeting and/or surveillance systems on the vehicle 102, timing information, and the like. In various implementations, the operational data conveyed to the vehicle management program 162 can include all or a portion of the mission critical information. In various implementations, all or a portion of the mission critical information can be stored in memory on the vehicle management program 162.

The vehicle management program 162 may generate the control data based on safety critical information. Safety critical information can include and/or be based on safety critical tests for the control data. The safety critical tests can be applied while the vehicle management program 162 generates the control data. For instance, while generating the control data, the program 162 can determine, based on the sensor data and/or operational data, that performing one or more tasks indicated by the mission critical information will fail a safety critical test. The safety critical tests can include any override condition for the vehicle 102. Override conditions can include determinations regarding vehicle safety such as a determination that the task will result in vehicle 102 failure (e.g., a vehicle crash, critical failure of vehicle engine systems, and/or the like). Override conditions can include determinations regarding safety of other subjects, such as vehicle passengers and/or persons outside the vehicle.

In various implementations, the operational data and/or sensor data conveyed to the vehicle management program 162 can include all or a portion of the safety critical information. In various implementations, all or a portion of the safety critical information can be stored in memory on the vehicle management board 124, such as in data stores 158.

As such, in various implementations, the vehicle management board 124 can generate the control data based on mission critical information, safety critical information, sensor data, operational data, or any combination thereof.

### Example Implementations and Features Related to Mission Critical and Safety Critical Domains

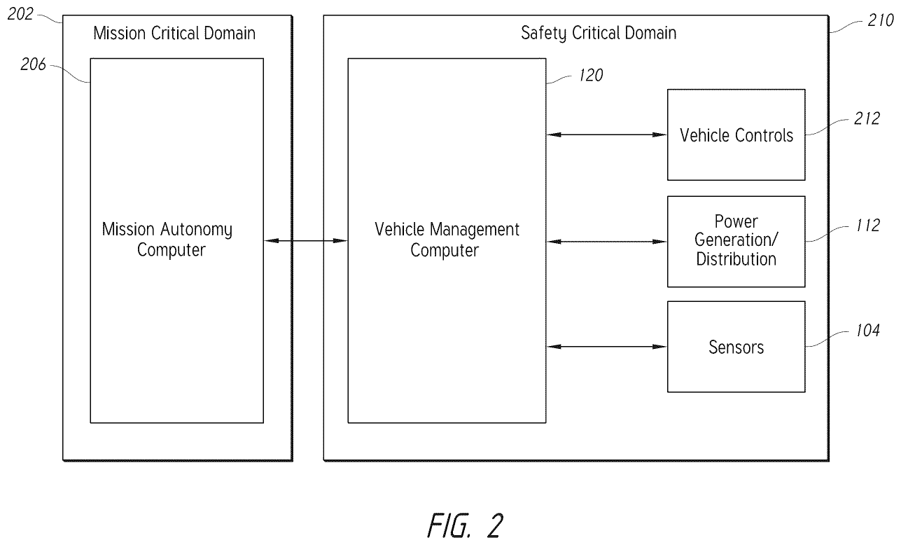

FIG. 2 illustrates a block diagram of an example partition of a mission critical domain 202 and a safety critical domain 210, according to various implementations. According to various implementations, the vehicle management system can include partitioning between mission-critical functionality and safety-critical functionality. As such, software and/or hardware components can be defined in the mission critical domain 202 or the safety critical domain 210. In various implementations, software and/or hardware components in the safety critical domain 210 are those software or hardware components, functions, or capabilities, of which a failure, malfunction, or absence could cause catastrophic failure or loss of control, resulting in the loss of persons or property.

As described above, the vehicle management system may generate control data for a vehicle based on mission critical information and safety critical information. Mission critical information can include one or more sets of instructions for a vehicle to accomplish an overall task. Safety critical information can include and/or be based on safety critical tests for the control data. The safety critical tests can include any override condition for the vehicle. According to various implementations, the override conditions for the vehicle can include conditions for maintaining safety critical domain 210 components.

Advantageously, the safety critical domain 210 can include all software or hardware components, functions, or capabilities needed to generate safety critical information. As such, even if a mission critical domain 202 component fails and/or communication between the safety critical domain 210 and the mission critical domain 202 is lost, the components of the safety critical domain 210 can continue to operate. In such a case, all the control data generated by the vehicle management computer 120 may include only information derived from safety critical domain 210 components.

As illustrated in FIG. 2, the mission critical domain 202 may include a mission autonomy computer 206. The mission autonomy computer 206 may include the mission computing devices 106 and/or the external computing devices 130 described in FIG. 1A. The mission autonomy computer 206 can generate mission critical information. For example, mission critical information can include locations for a vehicle to travel to, targets for targeting and/or surveillance systems on the vehicle, timing information, and the like. The mission autonomy computer 206 may communicate the mission critical information to the safety critical domain 210. For example, the mission autonomy computer 206 may transmit the mission critical information to the vehicle management computer 120. The mission critical information may be transmitted via wireless and/or wired communication methods.

As illustrated in FIG. 2, the safety critical domain 210 may include the vehicle management computer 120, vehicle controls 212, the power generation/distribution system 112, and the sensors 104. The vehicle controls 212 may include any system on the vehicle used to control the vehicle, such as the vehicle control systems 108, the vehicle subsystems 110, and/or the vehicle actuation/propulsion system 111, and/or the like.

In various implementations, some of the components illustrated in the safety critical domain 210 may have aspects that are not safety critical. For example, one or more of the sensors 104, such as a camera, may fail without causing catastrophic failure or loss of control, resulting in the loss of persons or property. However, if enough of the sensors 104 fail, such a condition may result. Similarly, the sensors 104 may contain one or more sensors that failure of which by themselves may cause catastrophic failure or loss of control.

In various implementations, the safety critical domain 210 can generate safety critical information. For example, the safety critical information can include and/or be based on information received from the sensors 104 and information from the vehicle management computer 120 (e.g., safety monitoring determinations, safety critical tests, contingency management determinations, and/or the like). The vehicle management computer 120 can receive mission critical information from the mission autonomy computer 206 and utilize the safety critical information to generate control data. For example, the vehicle management computer 120 can determine based on the mission critical information a desired operation. In this example, the vehicle management computer 120 can then determine, based on the safety critical information, if the desired operation passes a safety critical test and/or that the desired operation will not trigger an override condition. If the safety critical test is passed and/or the desired operation will not trigger an override condition, then the vehicle management computer 120 may generate control data to cause the vehicle to perform the desired task. If the safety critical test is not passed and/or the desired operation will trigger an override condition, then the vehicle management computer 120 may generate other control data, such as control data to cause the vehicle to avoid a system failure (e.g., to halt a launch, to return to base, to land safely, to avoid particular operations, and/or the like).

### Example Implementations and Features Related to Vehicle Management Program

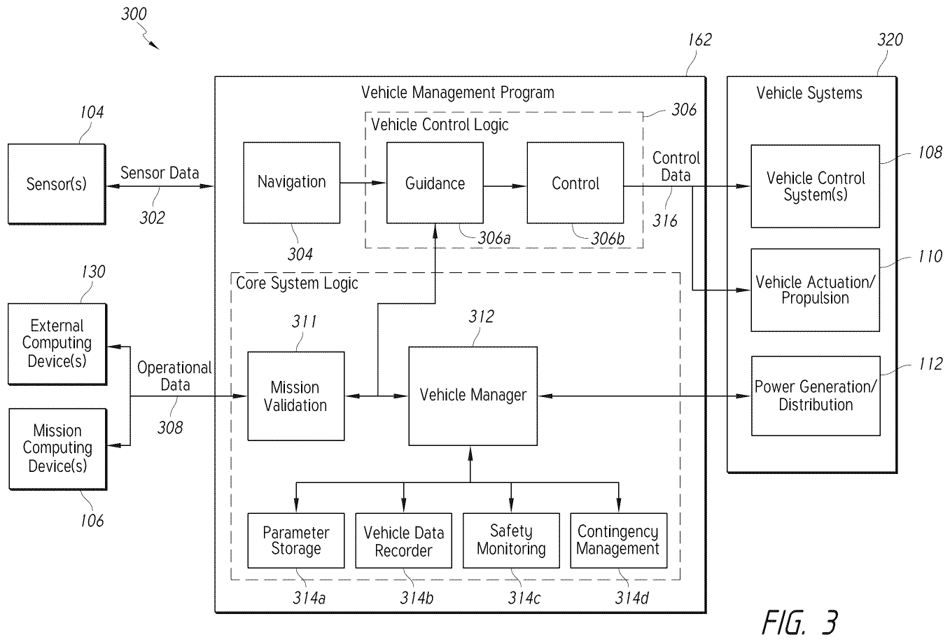

FIG. 3 illustrates a block diagram of an example software environment 300 for executing a vehicle management program 162, according to various implementations. The software environment 300 may comprise executable software instructions, modules, engines, and/or the like, that may communicate with one another to share computer resources to execute various tasks in conjunction with a specific functionality, such as the functionality described herein. The software environment 300 may be implemented by one or more processing modules (e.g., the software instructions may be stored in memory, and executed by the processor(s), GPU(s), signal transceiver(s), components thereof, and/or the like). For example, the software instructions may be stored and executed by the vehicle management computer 120.

The software environment 300 can include a vehicle management program 162. As previously described, the vehicle management program 162 can generate control data 316 from sensor data 302 and operational data 308. Some of or all the sensor data 302 may be generated by the sensors 104. In various implementations, some of or all the sensor data 302 may be stored and/or retrieved from storage. For example, some of or all the sensor data 302 used to generate a set of control data 316 may be stored and recalled by the parameter storage module 314a, vehicle data recorder module 314b, safety monitoring module 314c, and/or contingency management module 314d.

Some of or all the operational data 308 may be generated by the external computing devices 130 and/or the mission computing devices 106. In various implementations, some of or all the operational data 308 may be stored and/or retrieved from storage. For example, some of or all the operational data 308 used to generate a set of control data 316 may be stored and recalled by the parameter storage module 314a, vehicle data recorder module 314b, safety monitoring module 314c, and/or contingency management module 314d. In various implementations, a portion of the operational data 308 may be generated by the power generation/distribution system 112. For example, the operational data 308 may include information about available power to a vehicle.

In various implementations, the vehicle management program 162 can include a navigation module 304, vehicle control logic 306, and core system logic 310. The vehicle control logic 306 can include a guidance module 306a and a control module 306b. The core system logic 310 can include a mission validation module 311, a vehicle manager module 312, and storage modules, such as parameter storage module 314a, vehicle data recorder module 314b, safety monitoring module 314c, and contingency management module 314d.

### Example Aspects Related to Navigation Module 304

The navigation module 304 can receive sensor data 302 and determine navigational information associated with a vehicle. For example, for an aerial type vehicle, the navigation module 304 can receive sensor data 302 and determine vehicle positional information, altitude information, orientation information, velocity information, air data information, and/or the like. The navigational information can be input into the guidance module 306a of the vehicle controls logic 306.

### Example Aspects Related to Vehicle Control Logic 306

The vehicle control logic 306 can determine the control data 316 based on the navigational information received from the navigation module 304 and from desired operation instructions received from the core system logic 310. The guidance module 306a of the vehicle control logic 306 can determine a set of general instructions for the vehicle. For instance, the guidance module 306a can use the navigational information and the desired operation instructions to determine that an aerial type vehicle should change trajectory, such as increasing/decreasing altitude and/or turning in one or more directions, hold a current trajectory, control one or more sensors and/or cameras to view a target, and/or the like.

In various implementations, the guidance module 306a may query and/or share information back with the core system logic 310. For example, the guidance module 306a may share a determined set of general instructions with the core system logic 310 for use with the mission validation module 311 and/or the vehicle manager module 312. As another example, the guidance module 306a may query the vehicle manager module 312 for information used to determine the set of general instructions, such as a to receive a parameter from the parameter storage module 314a.

The set of general instructions determined by the guidance module 306a may be input into the control module 306b can determine a set of specific instructions for the vehicle and/or vehicle components. The set of specific instructions can be a series of single operations to perform the set of general instructions. For example, a general instruction for an aerial type vehicle may indicate the vehicle should increase cruising altitude. In this example, the control module 306b may determine a series of single operations for one or more vehicle components such as vehicle control systems 108 and/or vehicle actuation/propulsion system 111 that cause the vehicle to increase cruising altitude.

The control data 316 generated by the vehicle control logic 306 may include both sets of general instructions determined by the guidance module 306a and sets of specific instructions generated by the control module 306b. In various implementations, the control data 316 includes only the sets of specific instructions generated by the control module 306b. The control data 316 can be sent to the vehicle system 320 to control the vehicle.

### Example Aspects Related to Core System Logic 310

The core system logic 310 can determine desired operation instructions for the vehicle based on operational data 308 received from the external computing devices 130, mission computing devices 106, and/or the power generation/distribution system 112 and/or from operational data 308 recalled from storage in the vehicle management program 162, such as in the parameter storage module 314a, vehicle data recorder module 314b, safety monitoring module 314c, and/or contingency management module 314d. The desired operation instructions can be shared with the vehicle control logic 306 for use in determining control data 316.

The desired operation instructions can include and/or be derived from the operational data 308. The desired operation instructions can include sets of outcomes and/or actions for the vehicle to perform. Some examples of outcomes or actions for an aerial type vehicle can include one or more of: (1) move to a specific location, (2) perform a movement pattern such as circling an area or following an object, (3) control one or more sensors or cameras, (4) or the like. In various implementations, the desired operation instructions may not include and/or be derived from the operational data 308. For example, the operational data 308 may be rejected by the mission validation module 311 and/or fail one or more tests and/or criteria stored in the safety monitoring module 314c and/or contingency management module 314d. In this example, a set of desired operation instructions may include and/or be derived from information in the vehicle management program 162, such as in the parameter storage module 314a, vehicle data recorder module 314b, safety monitoring module 314c, and/or contingency management module 314d and/or information received from the power generation/distribution system 112.

The mission validation module 311 can perform validations on the operational data 308 received by the vehicle management program 162. Some examples of validations the mission validation module 311 may perform can include, but are not limited to, validating the operational data 308 was received from an authorized source, validating the vehicle management program 162 can execute one or more tasks indicated by the operational data 308, validation the operational data 308 was meant for the vehicle the vehicle management program 162 is installed in, validating the operational data 308 does not conflict with a current operation of the vehicle management program 162, and/or the like. The mission validation module 311 can perform the validations based on information received by the guidance module 306a and the vehicle manager module 312 as information stored in the in the parameter storage module 314a, vehicle data recorder module 314b, safety monitoring module 314c, and/or contingency management module 314d.

In various implementations, the mission validation module 311 may generate and/or convey all or a portion of the desired operation instructions based on a result of a validation. For example, the mission validation module 311 may convey validated operational data 308 as desired operation instructions to the vehicle control logic 306. In various implementations, the mission validation module 311 may convey validated operational data 308 to the vehicle manager module 312 for further processing.

The vehicle manager module 312 can manage information received from the mission validation module 311, the power generation/distribution system 112, the vehicle control logic 306, and/or information stored in the parameter storage module 314a, vehicle data recorder module 314b, safety monitoring module 314c, and/or contingency management module 314d to determine and/or convey desired operation instructions to the vehicle control logic 306. In various implementations, the vehicle manager module 312 can receive validated operational data 308 from the mission validation module 311 and determine if a task indicated by the validated operational data 308 triggers an override condition. Some examples of triggered override conditions can include, but are not limited to, a failure of a safety critical test stored in the safety monitoring module 314c, a conflict with contingency protocols stored in the contingency management module 314d, a determination that the task is impossible for the vehicle based on information from the parameter storage module 314a, the vehicle data recorder module 314b, and/or from the power generation/distribution system 112 (e.g., available power to the vehicle), and or the like.

The parameter storage module 314a can store information needed for determining desired operation instructions and/or control data 316. The information stored in the parameter storage module 314a can include values, computer-readable information, and/or the like. Examples of the information stored in the parameter storage module can include, but are not limited to, information specific to the vehicle and/or vehicle components, information for executing the vehicle management program 162, and/or the like. In various implementations, all or a portion of the information in the parameter storage module 314a is static. In various implementations, all or a portion of the information in the parameter storage module 314a is dynamic. For example, the information in the parameter storage module 314a may be updated by the vehicle manager module 312 with information from the operational data 308, sensor data 302, received from the vehicle control logic 306 and/or received from the power generation/distribution system 112.

The vehicle data recorder module 314b can store vehicle state information. In various implementations, the vehicle state information can include sensor data 302, navigational information generated by the navigation module 304, sets of general instructions, information from the power generation/distribution system 112, timing information, and/or the like. The vehicle state information may include a summary of the state of the vehicle at a particular time step. For example, the state of the vehicle can include vehicle position, location, power level, fuel level, the status of various vehicle components, such as actuators, controllers, and/or sensors, and/or the like for a given moment in time. The vehicle data recorder module 314b may store a log of the state of the vehicle for use in determining the desired operation instructions. For example, the vehicle manager module 312 can use the current state of the vehicle to determine what outcomes and/or actions the vehicle should perform based on the operational data 308, determine if a safety critical test is passed and/or the like.

The safety monitoring module 314c can store safety critical tests and/or other vehicle safety information. The safety critical tests can include any override condition for the vehicle. Override conditions can include determinations regarding vehicle safety such as a determination that the task will result in vehicle failure (e.g., a vehicle crash, critical failure of vehicle engine systems, and/or the like). Override conditions can include determinations regarding safety of other subjects, such as vehicle passengers or persons outside the vehicle. In various implementations, all or a portion of the safety critical tests can be static. In various implementations, all or a portion of the safety critical tests can be dynamically updated by the vehicle manager module 312 based on the operational data 308, sensor data 302, information received from the vehicle control logic 306 and/or information received from the power generation/distribution system 112.

The contingency management module 314d can store contingency information. In various implementations, the contingency information can include information used to overcome contingency scenarios, such as the failure of one or more vehicle sensors, controllers, actuators, and/or the like, loss of connection to an external computing device 130, and/or any other scenario that may require the vehicle management program 162 to alter normal vehicle operation. For example, the contingency information may include information associated with redundant vehicle sensors, controllers, actuators, and/or the like that can be used in case one or more vehicle sensors, controllers, actuators, and/or the like fail.

In various implementations, contingency information can include priority information so that the vehicle manager module 312 can prioritize certain tasks received as compared to prior or additional tasks received and/or any automated protocols.

### Example Aspects Related to Vehicle Systems 320

The vehicle systems 320 can include systems and/or subsystems on the vehicle that control the vehicle. For example, the vehicle systems 320 can include the vehicle control systems 108 the vehicle actuation/propulsion system 111, the power generation/distribution system 112, and/or any other system or subsystem configured to control the vehicle or a subsystem of the vehicle.

The vehicle systems 320 can receive the control data 316 and cause the various systems and/or subsystems on the vehicle to perform the sets of specific instructions and/or sets of general instructions. For example, the control data 316 may include a set of specific instructions to increase the output of one or more engines. In this example, the vehicle systems 320 can generate a control signal to cause more fuel to be sent to the one or more engines, generate a control signal to increase the RPM of the one or more engines, and/or the like. In another example, the control data 316 may include a set of specific change a flap position. In this example, the vehicle systems 320 can generate a control signal to one or more actuators on the vehicle to orient the flap according to the control data 316.

### Example Implementations and Features Related to Vehicle-Specific Board and Vehicle Management Board

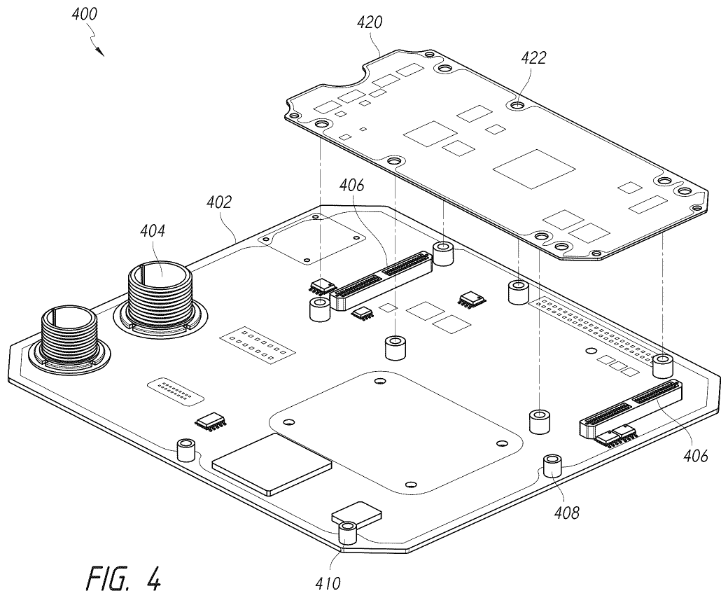

FIG. 4 illustrates an example implementation of a vehicle-specific board 402 and vehicle management board 420. In various implementations, the vehicle-specific board 402 may correspond to the vehicle-specific board 122 of FIG. 1B and the vehicle management board 420 may correspond to the vehicle management board 124 of FIG. 1C.

The vehicle-specific board 402 illustrated in FIG. 4 may correspond to a particular vehicle type. As such, some of the components of the vehicle-specific board 402 illustrated in FIG. 4 may be specific to the particular vehicle type. The vehicle-specific board 402 may include one or more external connectors 404, one or more vehicle management board connectors 406, one or more physical connectors 408, and one or more physical connectors 410.

In various implementations, the external connectors 404 may correspond to the external connectors 146 of FIG. 1B. The external connectors 404 may be specific to the particular vehicle type the vehicle-specific board 402 is implemented in. For example, external connectors 404 may correspond to external connectors used in a submarine. As such, the external connectors 404 may appear differently, be place differently, include different components, and/or the like, on a vehicle-specific board 402 associate with a different particular vehicle type. As previously described, the external connectors 404 can include electrical connections to receive sensor data, operational data, and/or power from the vehicle the vehicle-specific board 402 is implemented in and/or convey control data received from the vehicle management board 420 to sensors, controllers, actuators, and/or the like, on the vehicle.

In various implementations, the vehicle management board connectors 406 may correspond to the vehicle management board connectors 144 of FIG. 1B. The vehicle management board connectors 406 may be agnostic to the type of vehicle the vehicle-specific board 402 is implemented in. For example, vehicle management board connectors 406 may have the same or similar physical characteristics and/or footprint, connectors, pins, jacks, and/or the like regardless of the particular vehicle type the vehicle-specific board 402 is implemented in. As previously described, the vehicle management board connectors 406 can include electrical couplings to provide and/or convey sensor data, operational data, and/or electrical power to the vehicle management board 420 and/or to receive control data from the vehicle management board 420.

In various implementations, the physical connectors 408 and/or the physical connectors 410 may correspond to the physical connectors 148 of FIG. 1B. The physical connectors 408 and/or the physical connectors 410 may include, for example, fasteners, such as screws, anchors, clips, and the like. The physical connectors 410 can be used to physically couple and decouple the vehicle-specific board 402 to a vehicle. The physical connectors 408 can be used to physically couple and decouple the vehicle-specific board 402 to the vehicle management board 420.

The location of the physical connectors 410 on the vehicle-specific board 402 may depend on the particular vehicle type the vehicle-specific board 402 is implemented in. For example, the location of the physical connectors 410 on the vehicle-specific board 402 may depend on the location of corresponding physical connectors on the vehicle. Similarly, the location of the physical connectors 408 may depend on the particular vehicle type the vehicle-specific board 402 is implemented in. However, the relative location of each of the physical connectors 408 to the other physical connectors 408 and/to the vehicle management board connectors 406 may be the same and/or similar regardless of the particular vehicle type the vehicle-specific board 402 is implemented in. As such, vehicle management board 420 may be useable with the vehicle-specific board 402 illustrated in FIG. 4 and usable for vehicle0specific boards implemented in any of multiple types of vehicles.

The vehicle management board 420 illustrated in FIG. 4 may be usable with vehicle-specific boards associated with various vehicle types. As such, while FIG. 4 illustrates vehicle management board 420 as coupling to the vehicle-specific board 402 implemented in a particular vehicle type, vehicle management board 420 may be useable with vehicle-specific boards for any of multiple types of vehicles. The vehicle management board 420 may include one or more physical connectors 422 and one or more vehicle-specific board connectors (not illustrated in FIG. 4).

In various implementations, the physical connectors 422 may correspond to the physical connectors 160 of FIG. 1C. The physical connectors 422 may include, for example, fasteners, such as screws, anchors, clips, and the like. to physically couple and decouple the vehicle management board 420 to the vehicle-specific board 402.

In various implementations, the vehicle-specific board couplings on the vehicle management board 420 may correspond to the vehicle-specific board connectors 154 of FIG. 1C. The vehicle-specific board couplings on the vehicle management board 420 can include electrical couplings to provide and/or convey control data to the vehicle-specific board 402 and/or receive convey sensor data, operational data, and/or electrical power from the vehicle-specific board 402 and/or from a vehicle through the vehicle-specific board 402.

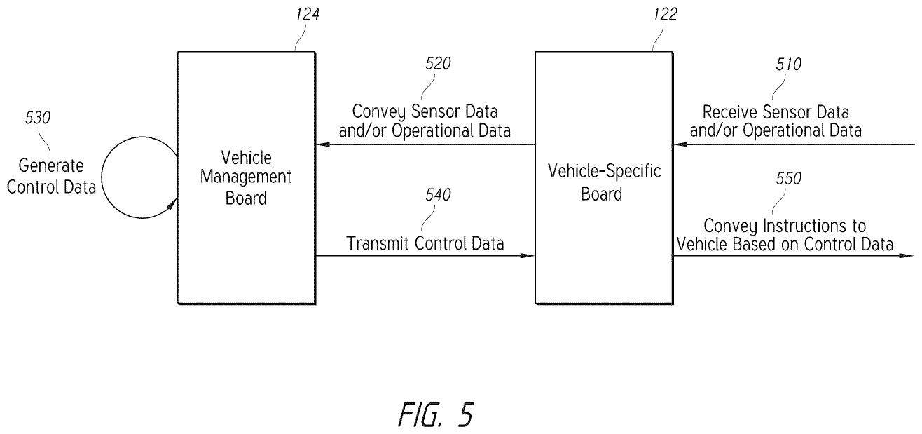

FIG. 5 illustrates a flow diagram depicting example functionality of the vehicle management system, such as by the vehicle management computer 120 of FIG. 1A, according to various implementations. In various implementations, functions, acts, or events described in FIG. 5 can be performed in a different order or concurrently.

At action 510, the vehicle-specific board 122 receives sensor data and/or operational data from a vehicle. As previously described, the sensor data can be information generated by one or more sensors located on the vehicle. Sensor data can include information gathered about the vehicle, such as vehicle position, vehicle location, the status of the vehicle and/or vehicle components, and/or other information collected about the vehicle. The sensor data can be collected by individual sensors and/or systems of sensors located on the vehicle. The sensor data can vary depending on the vehicle type and/or the sensors on a particular vehicle. For example, sensor data from collected from a submarine may include data from a sonar system that may not be installed on a UAV.

The operational data can be information generated by one or more computing devices, such as computing devices located on the vehicle and/or computing devices external to the vehicle and transmitted to the vehicle via a datalink 140. The operational data can include any instructions for the vehicle and/or instructions for vehicle components, such as mission payloads, navigation waypoints, vehicle states, and/or any other instructions for the vehicle and/or vehicle components described herein. For example, the operational data can include GPS coordinates for a UAV to navigate to and instructions for one or more camera systems located on the UAV.

At action 520, the vehicle-specific board 122 coveys the sensor data and/or operational data to the vehicle management board 124. In various implementations, the vehicle-specific board 122 may act as a conduit from the vehicle to the vehicle management board 124 for the sensor data and/or operational data. In such implementations, the sensor data and/or operational data may be unaltered or minimally altered (e.g., by a noise removing filter) by the vehicle-specific board 122. The sensor data and/or operational data may be conveyed via one or more connectors, such as the vehicle management board connectors 144 of FIG. 1B.

At action 530, the vehicle management board 124 generates control data for the vehicle based at least in part on the sensor data and/or the operational data. As previously described, the control data can include the information needed to control, operate, and/or manage the vehicle. For example, the control data can include instruction, control signals, and/or the like to control various actuators, engines, motors, drive trains, gear boxes, transmissions, control surfaces, servos, power generation systems, power distribution systems, and/or the like, positioned on the vehicle. The control data can be utilized by one or more control systems on the vehicle, examples of which are provided herein.

At action 540, the vehicle management board 124 transmits the control data to the vehicle-specific board 122. The vehicle management board 124 may transmit the control data by using one or more connectors such as the vehicle-specific board connectors 154 of FIG. 1C.

At action 550, the vehicle-specific board 122 can convey instructions to vehicle based on the control data. For example, the vehicle-specific board 122 can convey instructions to sensors, controllers, actuators, and/or the like, such as ECUs, ESCs, DEECs, and FADEC systems, and/or the like. In various implementations, the instructions conveyed to each vehicle component may comprise a portion of the control data. For example, a portion of the control data may be configured to control a particular sensor on the vehicle.

In various implementations, the vehicle-specific board 122 does not process the control data received from the vehicle management board 124. As such, the vehicle-specific board 122 may act as a conduit from the vehicle management board 124 to the vehicle and/or vehicle components for the control data.

Example Operations and/or Functionality of the Vehicle Management System

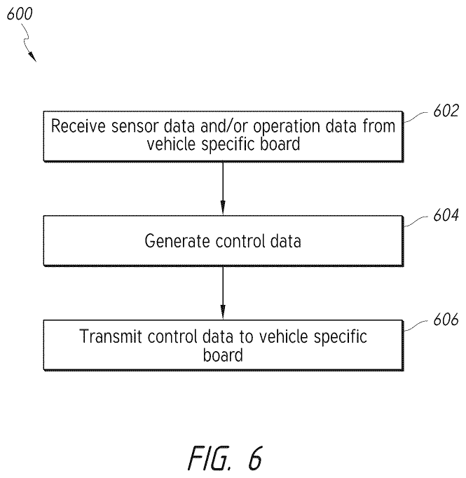

FIGS. 6-8 are flow charts illustrating example flows, methods, operations, and/or functionality of the vehicle management computer 120 (and/or various other aspects of the vehicle management system and/or computing environment 100 of the vehicle management system), according to various implementations. The blocks of the flow charts illustrate example implementations, and in various other implementations various blocks may be rearranged, optional, and/or omitted, and/or additional block may be added. In various implementations, the example operations of the system illustrated in FIGS. 6-8 may be implemented, for example, by the one or more aspects of the vehicle management computer 120, such as the vehicle-specific board 122 and/or the vehicle management board 124, various other aspects of the vehicle management system, and/or the like.

FIG. 6 is a flow chart depicting an example process 600 for generating control data. In various implementations, process 600 can be implemented by the vehicle management board 124. As noted above, the vehicle management board 124 can generate control data for a vehicle based on information received from or through the vehicle-specific board, such as the sensor and operational data. The control data can be utilized by one or more control systems on the vehicle. The vehicle management board 124 can generate the control data based in part on sensor data and/or operational data received from the vehicle-specific board.

At block 602, the vehicle management board 124 receives sensor data and/or operational data from a vehicle specific board, such as vehicle-specific board 122. In various implementations, the vehicle-specific board 122 may act as a conduit from a vehicle to the vehicle management board 124 for the sensor data and/or operational data. In such implementations, the sensor data and/or operational data may be unaltered or minimally altered (e.g., by a noise removing filter) by the vehicle-specific board 122. The sensor data and/or operational data may be received via one or more connectors such as the vehicle-specific board connectors 154 of FIG. 1C.

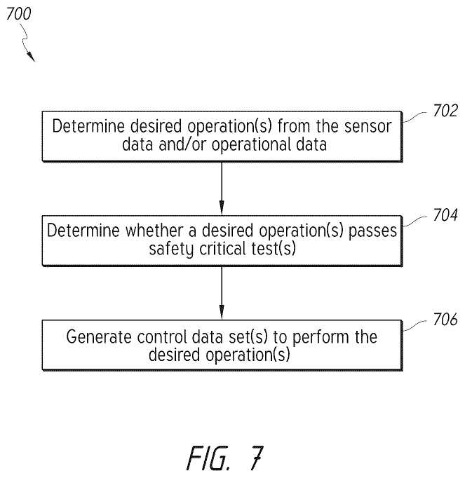

At block 604, the vehicle management board 124 generates control data for the vehicle. For example, the vehicle management board 124 can generate the control data based at least in part on the sensor data and/or the operational data received from the vehicle specific board. In various implementations, the vehicle management board 124 can generate control data based at least in part on the one or more safety critical tests described in FIG. 7.

At block 606, the vehicle management board 124 transmits the control data to the vehicle specific board. The vehicle management board 124 may transmit the control data via one or more connectors such as the vehicle-specific board connectors 154 of FIG. 1C.

FIG. 7 is a flow chart depicting an example process 700 for generating control data. In various implementations, process 700 can be implemented by the vehicle management board 124. As noted above, the vehicle management board 124 may generate the control data based on safety critical information. Safety critical information can include and/or be based on safety critical tests for the control data. The safety critical tests can be applied while the vehicle management board 124 generates the control data. For instance, while generating the control data, the system can determine, based on the sensor data and/or operational data, that performing one or more tasks indicated by the sensor data and/or operational data will fail a safety critical test. The safety critical tests can include an override condition for the vehicle. Override conditions can include determinations regarding vehicle safety such as a determination that the task will result in vehicle failure (e.g., a vehicle crash, critical failure of vehicle engine systems, and/or the like). Override conditions can include determinations regarding safety of other subjects, such as vehicle passengers or persons outside the vehicle. In various implementations, the operational data and/or sensor data conveyed to the vehicle management board 124 can include all or a portion of the safety critical information.

At block 702, the vehicle management board 124 determines a desired operation from the sensor data and/or operational data. As noted above, the sensor data and/or operational data can include sets of instructions for the vehicle to accomplish an overall task. For example, the sensor data and/or operational data can include locations for the vehicle 102 to travel to, targets for targeting and/or surveillance systems on the vehicle 102, timing information, and the like. The vehicle management board 124 can determine one or more desired operations for the vehicle to, based on the sets of instructions. For example, for a set of instructions for the vehicle 102 to travel to a location, the vehicle management board 124 may determine a vehicle trajectory change as a desired operation.

At block 704, the vehicle management board 124 determines whether one or more of the desired operations passes one or more safety critical tests. For example, a vehicle trajectory change, the vehicle management board 124 may determine if the vehicle trajectory change will result in vehicle failure, such as a vehicle crash. In various implementations, if the vehicle management board 124 determines a desired operation fails one or more safety critical tests, the vehicle management board 124 may determine a different desired operation and/or ignore the desired operation. For example, if vehicle management board 124 determines a vehicle trajectory change will result in vehicle failure, the vehicle management board 124 may determine a series of trajectory changes that will not result in vehicle failure or may determine to hold the current trajectory.

At block 706, the vehicle management board 124 generates one or more control data sets to perform the desired operation. For example, the vehicle management board 124 can generate one or more control signals that can be used by sensors, controllers, actuators, and/or the like on the vehicle 102 to change vehicle trajectory.

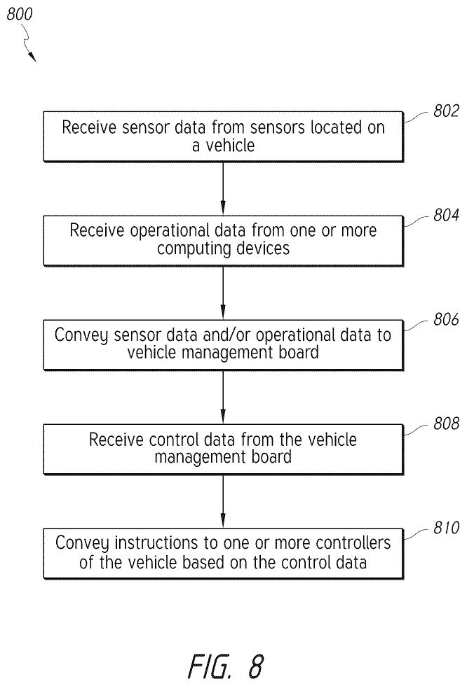

FIG. 8 is a flow chart depicting an example process 800 for generating control data. In various implementations, process 800 can be implemented by the vehicle-specific board 122. As noted above, the vehicle-specific board 122 can receive sensor data from a vehicle 102. The sensor data can be information generated by one or more sensors located on the vehicle 102. Sensor data can include information gathered about the vehicle 102, such as vehicle position, vehicle location, the status of the vehicle 102 and/or vehicle components, and/or other information collected about the vehicle 102. The sensor data can be collected by individual sensors and/or systems of sensors located on the vehicle 102. The sensor data can vary depending on the vehicle type and/or the sensors on a particular vehicle. For example, sensor data collected from a submarine may include data from a sonar system that may not be installed on a UAV.

The vehicle-specific board 122 can further receive operational data from the vehicle 102. The operational data can be information generated by one or more computing devices, such as computing devices located on the vehicle 102 and/or computing devices external to the vehicle 102 and transmitted to the vehicle 102 via a datalink 140. The operational data can include any instructions for the vehicle 102 and/or instructions for vehicle components, such as mission payloads, navigation waypoints, and/or vehicle states, and/or the like. For example, the operational data can include GPS coordinates for a UAV to navigate to and instructions for one or more camera systems located on the UAV.

The vehicle-specific board 122 can receive control data from a vehicle management board 124. The vehicle-specific board 122 can convey instructions to vehicle sensors, controllers, actuators, and/or the like, based on the control data. The control data can include the information needed to control, operate, and/or manage the vehicle 102. For example, the control data can include instruction, control signals, and/or the like to control various actuators, engines, motors, drive trains, gear boxes, transmissions, control surfaces, servos, power generation systems, power distribution systems, and/or the like, positioned on the vehicle 102. The control data can be utilized by one or more control systems on the vehicle 102.

At block 802, the vehicle-specific board 122 receives the sensor data from sensors located on the vehicle 102. For example, the vehicle-specific board 122 can receive sensor data can from one or more PNT-related sensors, and/or other types of sensors, located on the vehicle 102. At block 804, the vehicle-specific board 122 can receive operational data from one or more computing devices. For example, the vehicle-specific board 122 can receive operational data from computing devices located on the vehicle 102 and/or computing devices external to the vehicle 102 and transmitted to the vehicle 102 via a datalink 140.

At block 806, the vehicle-specific board 122 conveys the sensor data and/or operational data to the vehicle management board 124. In various implementations, the vehicle-specific board 122 may act as a conduit from the vehicle 102 to the vehicle management board 124 for the sensor data and/or operational data. In such implementations, the sensor data and/or operational data may be unaltered or minimally altered (e.g., by a noise removing filter) by the vehicle-specific board 122. The sensor data and/or operational data may be conveyed via one or more connectors, such as the vehicle management board connectors 144 of FIG. 1B.

At block 808, the vehicle-specific board 122 receives control data from the vehicle management board 124. The vehicle-specific board 122 may receive the control data via one or more connectors, such as the vehicle management board connectors 144 of FIG. 1B.

At block 810 the vehicle-specific board 122 can convey instructions to one or more controllers of the vehicle 102 based on the control data. For example, the vehicle-specific board 122 can convey instructions to sensors, controllers, actuators, and/or the like, such as ECUs, ESCs, DEECs, and FADEC systems, and/or the like. In various implementations, the instructions conveyed to each vehicle component may comprise a portion of the control data. For example, a portion of the control data may be configured to control a particular sensor on the vehicle 102.

In various implementations, the vehicle-specific board 122 does not process the control data received from the vehicle management board 124. As such, the vehicle-specific board 122 may act as a conduit from the vehicle management board 124 to the vehicle 102 and/or vehicle components for the control data.

### Additional Implementation Details and Embodiments

FIG. 9 illustrates a block diagram of an example operational environment 9000 of the system, according to various implementations. The example operational environment 9000 can be similar to, or the same as, or include components similar to the computing environment 100 described in reference to FIG. 1A. The operational environment 9000 can include one or more vehicles 102 (e.g., various vehicles and/or systems described below in reference to FIG. 9), one or more external computing devices 130 (e.g., Lattice system 9010, command and control system(s) 9080, and/or other components described below in reference to FIG. 9), one or more data sources 132 (e.g., various sensors and systems described below in reference to FIG. 9), one or more networks or datalinks 140 (e.g., various networks and/or datalinks described below in reference to FIG. 9), and/or additional components as described herein.

For example, and as illustrated in the example of FIG. 9, the operational environment 9000 can include vehicles such as land system(s) 9040, maritime system(s) 9050, air and/or space system(s) 9060, and/or counter unmanned arial system(s) 9030 (referred to herein as “CUAS(s)” 9030). As also illustrated, the operational environment 9000 can include external computing devices such as a Lattice system 9010, command and control system(s) 9080, and/or the like. As further illustrated, the operational environment 9000 can include data sources and/or sensors such as one or more sensor(s) and/or sensor tower(s) 9020, and/or CUAS(s) 9030. As also illustrated, the operational environment 9000 can include networks and/or datalinks such as network and/or datalink 9002 (which can be similar to network 140) which can provide communications among the various components of the operational environment 9000. The operational environment 9000 can also include various direct and/or alternative communications links among various components, such as communications link 9004 between the Lattice system 9010 and the command and control system 9080.

The groupings of components in the example operational environment 9000 illustrated in FIG. 9 and described above is illustrative and not limiting. For example, various components may fall into groups different from those described above, and/or into multiple groups. For example, any of the various vehicles (e.g., land system 9040, maritime systems 9050, air and space systems 9060) may also include sensor and/or data source functionality by way of various sensors (e.g., cameras, radar devices, and/or any other sensors 104) included in or on those vehicles. Similarly, any of the various sensors (e.g., sensors and sensor towers 9020, CUASs 9030, and/or the like) may also comprise and/or be associated with vehicles. Further, the operational environment 9000 can include components different from those described in reference to FIG. 9, and/or additional system(s) (e.g., vehicles, computing systems, and/or the like) and/or sensor(s) 9070.

Sensors and sensor towers 9020 can include, for example, a sentry tower 9022. Examples of such sensor towers and associated functionality are described in U.S. Patent Publication No. 2022/0377232, published Nov. 24, 2022, and titled “Auto-Focus Acquisition For Remote Flying Targets” (the '232 Publication), and U.S. Patent Publication No. 2022/0377242, published Nov. 24, 2022, and titled “Auto-Focus Tracking For Remote Flying Targets” (the '242 Publication), the entire disclosures of each of which are hereby made part of this specification as if set forth fully herein and incorporated by reference for all purposes, for all that they contain.

CUASs 9030 can include, for example, a long range sentry tower 9032, a wide-area infrared system for persistent surveillance (“WISP”) 9033, a software-defined electromagnetic warfare (“EW”) device/system (“Pulsar system”) 9034, and/or an autonomous counter unmanned arial system drone device (“Anvil device”) 9035. CUASs 9030 can include various autonomous functionalities, such as movement, goal seeking, ISR, and/or the like. Examples of such Pulsar systems and associated functionality are described in PCT International Publication No. 2023/225417, published Nov. 23, 2023, and titled “Modular System For Detecting, Tracking, And Transmitting To Identified Objects” (the '417 Publication), the entire disclosure of which is hereby made part of this specification as if set forth fully herein and incorporated by reference for all purposes, for all that it contains. Examples of such Anvil devices and associated functionality are described in U.S. Patent Publication No. 2020/0363824, published Nov. 19, 2020, and titled “Counter Drone System” (the '824 Publication), the entire disclosure of which is hereby made part of this specification as if set forth fully herein and incorporated by reference for all purposes, for all that it contains.

Land systems 9040 can include, for example, various land-based vehicles 9042, such as automobiles, tanks or other armored vehicles, all-terrain vehicles, and/or the like. Land systems 9040 can include various autonomous functionalities, such as movement, goal seeking, ISR, and/or the like.

Maritime systems 9050 can include, for example, a boat, a ship, and/or a submarine 9052. Maritime systems 9050 can include various autonomous functionalities, such as movement, goal seeking, ISR, and/or the like.

Air and/or space systems 9060 can include, for example, an extended-range unmanned aircraft system (“UAS”) 9062, an air-breathing autonomous air vehicle (“AAV”) 9063, a group 5 AAV 9064, a tandem rotor AAV 9065, a vertical take-off and landing (“VTOL”) AAV 9066, an autonomous launch effect 9067, an airplane, a balloon, a missile, a rocket, a satellite, and/or the like. Examples of such UASs and associated functionality are described in U.S. Patent Publication No. 2020/0126431, published Apr. 23, 2020, and titled “Ruggedized Autonomous Helicopter Platform” (the '431 Publication), the entire disclosure of which is hereby made part of this specification as if set forth fully herein and incorporated by reference for all purposes, for all that it contains. Examples of such tandem rotor AAVs and associated functionality are described in U.S. Patent Publication No. 2024/0262489, published Aug. 8, 2024, and titled “Dual Engine Vertical Take Off And Landing Collapsible Fixed Wing Aircraft” (the '489 Publication), the entire disclosure of which is hereby made part of this specification as if set forth fully herein and incorporated by reference for all purposes, for all that it contains. Examples of such autonomous launch effect and associated functionality are described in U.S. Pat. No. 9,545,991, issued Jan. 17, 2017, and titled “Aerial Vehicle With Deployable Components” (the '991 patent), the entire disclosure of which is hereby made part of this specification as if set forth fully herein and incorporated by reference for all purposes, for all that it contains.

In various implementations, and as described above, various components of the operational environment 9000 can advantageously include autonomous functionality. This means, for example, that submarine 9052 and/or VTOL AAV 9066 may be able to operate and pursue mission objectives and/or tasks autonomously. Such components may also be able to autonomously coordinate with each other in pursuit of mission objectives and/or tasks.

In various implementations, various components of the operational environment 900 can include munitions capabilities. Such capabilities may be used by these components in pursuit of mission objectives and/or tasks.

In various implementations, and as described above, various vehicles and systems of the operational environment 9000 can include sensor, munitions, and/or other functionality specific to the types of vehicles or systems. For example, a submarine may include SONAR functionality, a UAS or AAV may include camera functionality, and a sensor tower may include radar functionality.

The Lattice system 9010 can comprise a software platform advantageously capable of being used for a variety of missions and industries. The Lattice system 9010 can communicate with any type of sensor, network, and/or system, and can receive, integrate, and/or send data and/or communications. The Lattice system 9010 can move data received from the various systems with which it communicates into a single integration layer that that use AI, machine learning, and/or sensor and data processing techniques to, e.g., filter high-value information to users. The filtering and the functionality of the Lattice system 9010 can advantageously enable quick reactions to the data by tasking other systems such as sensors, vehicles, or other assets within and via the platform itself. Communications among the Lattice system 9010 and various components of the operational environment 9000 (e.g., vehicles, sensors, system, networks, and/or the like) can be provided via various networks and/or datalinks, and can include “mesh” type communications. Examples of such mesh and/or secure communications, and/or other functionality and/or operations of the Lattice system 9010, are described in U.S. Patent Publication No. 2019/0380032, published Dec. 12, 2019, and titled “Lattice Mesh” (the '032 Publication), the entire disclosure of which is hereby made part of this specification as if set forth fully herein and incorporated by reference for all purposes, for all that it contains.

The Lattice system 9010 can provide various ways of presenting data and/or enabling user interactions. This can include, for example, various interactive graphical user interfaces provided via user devices such as smartphones 9012 and/or other computing devices 9014. Further examples of sensors, vehicles, and/or systems in the operational environment 9000, and/or operation of the Lattice system 9010, are described in U.S. Patent Publication No. 2020/0167059, published May 28, 2020, and titled “Interactive Virtual Interface” (the '059 Publication), and the '824 Publication, the entire disclosures of each of which are hereby made part of this specification as if set forth fully herein and incorporated by reference for all purposes, for all that they contain.

The command and control system 9080 can include any existing and/or legacy systems for providing command and control over, for example, various sensors, systems, and/or vehicles. These command and control systems 9080 can include various computer systems, user interfaces 9082, hardware and/or devices 9083, and/or the like. The Lattice system 9010 can advantageously communicate with the command and control system 9080 and integrate with the command and control system 9080 to provide various of the functionality described herein. This can include, for example, communications and coordination with various sensors, systems, and/or vehicles, including execute missions and achieve operational objectives. These functionalities can include provide instructions to various autonomous systems, and enabling various systems to communicate and coordinate with each other.

Various components of the operational environment 9000 can include vehicle management computers 120 and/or other components and/or functionality of the present disclosure. For example, various of the CUASs 9030, land systems 9040, maritime systems 9050, and air and space systems 9060 can each include vehicle management computers 120. In each case, and as described herein, these vehicle management computers 120 can include respective common and/or similar vehicle management boards 124, and respective vehicle-specific boards 122. By way of the combination of the vehicle management board 124 and the vehicle-specific board 122, each vehicle and/or system can advantageously have functionality specific to that vehicle or system, or type of vehicle or system. Such functionality can include, as described herein, receiving sensor and/or operational data, and executing controls to perform tasks and/or seek mission objectives, within the operational environment 9000.

Various implementations of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some implementations, electronic circuitry including, for example, programmable logic circuitry, field-programmable gate arrays “(FPGA”), or programmable logic arrays (“PLA”) may execute the computer readable program instructions by utilizing state information of the computer readable program instructions to personalize the electronic circuitry, in order to perform aspects of the present disclosure.

Aspects of the present disclosure are described herein with reference to flow chart illustrations and/or block diagrams of methods, apparatus (systems), and computer program products according to implementations of the disclosure. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flow chart and block diagrams in the Figures illustrate the architecture, functionality, and operation of possible implementations of systems, methods, and computer program products according to various implementations of the present disclosure. In this regard, each block in the flow chart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flow chart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (“ASICs”)), programmable processors (e.g., field programmable gate arrays (“FPGAs”)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, etc.), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various implementations certain functionality may be accessible by a user through a web-based viewer (such as a web browser), or other suitable software program. In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of the implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1: A modular vehicle management system for an autonomous vehicle, the modular vehicle management system comprising: a vehicle management board configured to interface with any of a plurality of vehicle-specific boards including at least a first vehicle-specific board, the vehicle management board comprising: a first one or more connectors configured to receive operational data from the first vehicle-specific board and to send control data to the first vehicle-specific board; and one or more processors, wherein the one or more processors are configured to: receive the operational data from the first vehicle-specific board; generate, based at least in part on the operational data, the control data; and send the control data to the first vehicle-specific board; and the first vehicle-specific board interfaced with the vehicle management board, the first vehicle-specific board comprising: one or more vehicle data connections configured to provide communications with one or more computing devices and receive the operational data, wherein the one or more computing devices are configured to provide the operational data to the autonomous vehicle; a second one or more connectors configured to: interface with the first one or more connectors; convey the operational data to the vehicle management board; and receive the control data from the vehicle management board; and one or more vehicle operation connections configured to interface with one or more controllers of the autonomous vehicle.

Clause 2: The modular vehicle management system of clause 1, wherein the one or more computing devices comprises at least one external computing system.

Clause 3: The modular vehicle management system of clauses 1 or 2, wherein the first vehicle-specific board further comprises: one or more vehicle sensor connections configured to interface with one or more sensors located on the autonomous vehicle, wherein the one or more vehicle sensor connections are configured to receive the vehicle sensor data from the one or more sensors.

Clause 4: The modular vehicle management system of any of clauses 1-3, wherein to generate the control data the one or more processors are configured to: determine, based at least in part on the operational data and vehicle sensor data, a desired operation for the autonomous vehicle; determine, based at least in part on the operational data and vehicle sensor data, that the desired operation passes a safety critical test; and based on the desired operation passing the safety critical test, generate the control data, wherein the control data is configured to control the autonomous vehicle to perform the desired operation.

Clause 5: The modular vehicle management system of any of clauses 1-4, wherein the autonomous vehicle is unmanned.

Clause 6: The modular vehicle management system of any of clauses 1-5, wherein: the first vehicle-specific board further comprises: one or more power circuits configured to receive power from the autonomous vehicle and distribute power to the vehicle management board; and a third one or more connectors configured to interface with a fourth one or more connectors of the vehicle management board and distribute the power to the vehicle management board, wherein the fourth one or more connectors are configured to receive power from the first vehicle-specific board.

Clause 7: The modular vehicle management system of clause 6, wherein the one or more power circuits include at least one power conversion circuit configured to convert power from a first type provided by the autonomous vehicle to a second type based on a board type of the first vehicle-specific board.

Clause 8: The modular vehicle management system of any of clauses 1-7, wherein the one or more vehicle operation connections communicate instructions to the one or more controllers of the autonomous vehicle based on the control data.

Clause 9: The modular vehicle management system of any of clauses 1-8, wherein the vehicle management board further comprises: one or more computer-readable storage mediums storing program instructions, wherein the one or more processors are configured to execute the program instructions to cause the vehicle management board to: receive the operational data from the first vehicle-specific board; generate the control data; and send the control data to the first vehicle-specific board.

Clause 10: The modular vehicle management system of clause 9, wherein: the vehicle management board further comprises field programmable gate array (“FPGA”) architecture; and the one or more processors are further configured to execute the program instructions to cause the vehicle management board to: configure the FPGA architecture based on at least one of: the vehicle sensor data; the operational data; or a board type of the first vehicle-specific board.

Clause 11: The modular vehicle management system of any of clauses 1-10, wherein the autonomous vehicle communicates with at least one external computing device configured to integrate data received from the autonomous vehicle and at least one of: a different external computing device; a different vehicle; or an external sensor.

Clause 12: The modular vehicle management system of any of clauses 1-11, wherein the autonomous vehicle communicates with a second autonomous vehicle with a second modular vehicle management system comprising: a second vehicle management board configured to interface with any of the plurality of vehicle-specific boards including at least the first vehicle-specific board and a second vehicle-specific board; and the second vehicle-specific board interfaced with the second vehicle management board.

Clause 13: The modular vehicle management system of any of clauses 1-12, wherein the autonomous vehicle communicates with at least one external sensor.

Clause 14: A method comprising: by a vehicle management board: receiving operational data from a first vehicle-specific board; generating, based at least on the operational data and vehicle sensor data, control data; and transmitting the control data to the first vehicle-specific board; and by the first vehicle-specific board: receiving the operational data from one or more computing devices; conveying the operational data to the vehicle management board; receiving the control data from the vehicle management board; and based on the control data, conveying instructions to one or more controllers of an autonomous vehicle.

Clause 15: The method of clause 14, wherein generating the control data comprises: determining, based at least in part on the operational data and the vehicle sensor data, a desired operation for the autonomous vehicle; determining, based at least in part on the operational data and the vehicle sensor data, that the desired operation passes a safety critical test; and based on the desired operation passing the safety critical test, generating the control data, wherein the control data is configured to control the autonomous vehicle to perform the desired operation.

Clause 16: The method of clauses 14 or 15, further comprising: configuring a field programmable gate array (“FPGA”) of the vehicle management board based on at least one of: the vehicle sensor data; the operational data; or a board type of the first vehicle-specific board.

Clause 17: The method of any of clauses 14-16, wherein the autonomous vehicle is unmanned.

Clause 18: The method of any of clauses 14-17, further comprising: communicating with at least one external computing device configured to integrate data received from the autonomous vehicle and at least one of: a different external computing device; a different autonomous vehicle; or an external sensor.

Clause 19: The method of any of clauses 14-18, further comprising: communicating with a second autonomous vehicle.

Clause 20: The method of any of clauses 14-19, further comprising: communicating with at least one external sensor.

Clause 21: A modular vehicle management system for an unmanned vehicle, the modular vehicle management system comprising: a vehicle management board configured to interface with any of a plurality of vehicle-specific boards including at least a first vehicle-specific board, the vehicle management board comprising: a first one or more connectors configured to receive sensor data from the first vehicle-specific board and to send control data to the first vehicle-specific board; and one or more processors, wherein the one or more processors are configured to: receive the sensor data from the first vehicle-specific board; generate the control data based at least on the sensor data; and send the control data to the first vehicle-specific board; and the first vehicle-specific board interfaced with the vehicle management board, the first vehicle-specific board comprising: one or more vehicle sensor connections configured to interface with one or more sensors located on the unmanned vehicle, wherein the one or more vehicle sensor connections are configured to collect the sensor data from the one or more sensors; a second one or more connectors configured to: interface with the first one or more connectors; convey the sensor data to the vehicle management board; and receive the control data from the vehicle management board; and one or more vehicle operation connections configured to interface with one or more controllers of the unmanned vehicle.

Clause 22: The modular vehicle management system of clause 21, wherein the vehicle management board further comprises one or more programmable circuits.

Clause 23: The modular vehicle management system of clause 22, wherein the one or more programmable circuits includes field programmable gate array (“FPGA”) architecture.

Clause 24: The modular vehicle management system of clause 23, wherein the FPGA architecture includes one or more dynamically configurable connection ports to communicate at least a portion of the control data to the first vehicle-specific board.

Clause 25: The modular vehicle management system of clause 24, wherein the one or more dynamically configurable connection ports is configured, at least in part by the FPGA architecture, to provide communications specific to a board type of the first vehicle-specific board.

Clause 26: The modular vehicle management system of any of clauses 21-25, wherein: the first vehicle-specific board further comprises: one or more power circuits configured to receive power from the unmanned vehicle and distribute power to the vehicle management board; and a third one or more connectors configured to interface with a fourth one or more connectors of the vehicle management board and distribute the power to the vehicle management board, wherein the fourth one or more connectors are configured to receive power from the first vehicle-specific board.

Clause 27: The modular vehicle management system of clause 26, wherein the one or more power circuits include at least one power conversion circuit configured to convert power from a first type provided by the unmanned vehicle to a second type based on a board type of the first vehicle-specific board.

Clause 28: The modular vehicle management system of any of clauses 21-27, wherein the first one or more connectors are configured to provide decouplable mechanical and electrical connections with corresponding second one or more connectors of any of the plurality of vehicle-specific boards.

Clause 29: The modular vehicle management system of any of clauses 21-28, wherein the first vehicle-specific board is interfaced with the vehicle management board via the first one or more connectors and the second one or more connectors.

Clause 30: The modular vehicle management system of any of clauses 21-29, wherein the unmanned vehicle is autonomous.

Clause 31: The modular vehicle management system of any of clauses 21-30, wherein the first vehicle-specific board is a conduit to the vehicle management board for the sensor data and the control data.

Clause 32: The modular vehicle management system of any of clauses 21-31, wherein the one or more sensors located on the unmanned vehicle comprise at least one of: one or more global positioning system (“GPS”) sensors; one or more inertial navigation system (“INS”) sensors; one or more air data sensors; one or more gyroscopes; one or more accelerometers; or one or more altimeters.

Clause 33: The modular vehicle management system of any of clauses 21-32, wherein the one or more vehicle operation connections communicate instructions to the one or more controllers of the unmanned vehicle based on the control data.

Clause 34: The modular vehicle management system of clause 21, wherein the vehicle management board further comprises: one or more computer-readable storage mediums storing program instructions, wherein the one or more processors are configured to execute the program instructions to cause the vehicle management board to: receive the sensor data from the first vehicle-specific board; generate the control data based at least on the sensor data; and send the control data to the first vehicle-specific board.

Clause 35: The modular vehicle management system of clause 34, wherein: the vehicle management board further comprises field programmable gate array (“FPGA”) architecture; and the one or more processors are further configured to execute the program instructions to cause the vehicle management board to: configure the FPGA architecture based on at least one of: the sensor data; the operational data; or a board type of the first vehicle-specific board.

Clause 36: The modular vehicle management system of any of clauses 21-35, wherein the unmanned vehicle communicates with at least one external computing device configured to integrate data received from the unmanned vehicle and at least one of: a different external computing device; a different vehicle; or an external sensor.

Clause 37: The modular vehicle management system of any of clauses 21-36, wherein the unmanned vehicle communicates with one or more of a second vehicle or at least one external sensor, the second vehicle having a second modular vehicle management system comprising: a second vehicle management board configured to interface with any of the plurality of vehicle-specific boards including at least the first vehicle-specific board and a second vehicle-specific board; and the second vehicle-specific board interfaced with the second vehicle management board.

Clause 38: A method comprising: by a vehicle management board: receiving sensor data from a first vehicle-specific board; generating control data based at least on the sensor data; and transmitting the control data to the first vehicle-specific board; and by the first vehicle-specific board: receiving the sensor data from one or more sensors located on an unmanned vehicle; conveying the sensor data to the vehicle management board; receiving the control data from the vehicle management board; and based on the control data, conveying instructions to one or more controllers of the unmanned vehicle.

Clause 39: The method of clause 38, further comprising: communicating with at least one external computing device configured to integrate data received from the unmanned vehicle and at least one of: a different external computing device; a different vehicle; or an external sensor.

Clause 40: The method of clauses 38 or 39, further comprising: communicating with one or more of a second vehicle or at least one external sensor.

What is claimed is:

1. A modular vehicle management system for an autonomous vehicle, the modular vehicle management system comprising:
a vehicle management board configured to interface with any of a plurality of vehicle-specific boards including at least a first vehicle-specific board, the vehicle management board comprising:
a first one or more connectors configured to receive operational data from the first vehicle-specific board and to send control data to the first vehicle-specific board; and
one or more processors, wherein the one or more processors are configured to:
receive the operational data from the first vehicle-specific board;
generate, based at least in part on the operational data, the control data; and
send the control data to the first vehicle-specific board; and
the first vehicle-specific board interfaced with the vehicle management board, the first vehicle-specific board comprising:
one or more vehicle data connections configured to provide communications with one or more computing devices and receive the operational data, wherein the one or more computing devices are configured to provide the operational data to the autonomous vehicle;
a second one or more connectors configured to:
interface with the first one or more connectors;
convey the operational data to the vehicle management board; and
receive the control data from the vehicle management board; and
one or more vehicle operation connections configured to interface with one or more controllers of the autonomous vehicle.

2. The modular vehicle management system of claim 1, wherein the one or more computing devices comprises at least one external computing system.

3. The modular vehicle management system of claim 1, wherein the first vehicle-specific board further comprises:
one or more vehicle sensor connections configured to interface with one or more sensors located on the autonomous vehicle, wherein the one or more vehicle sensor connections are configured to receive the vehicle sensor data from the one or more sensors.

4. The modular vehicle management system of claim 1, wherein to generate the control data the one or more processors are configured to:
determine, based at least in part on the operational data and vehicle sensor data, a desired operation for the autonomous vehicle;
determine, based at least in part on the operational data and vehicle sensor data, that the desired operation passes a safety critical test; and
based on the desired operation passing the safety critical test, generate the control data, wherein the control data is configured to control the autonomous vehicle to perform the desired operation.

5. The modular vehicle management system of claim 1, wherein the autonomous vehicle is unmanned.

6. The modular vehicle management system of claim 1, wherein:
the first vehicle-specific board further comprises:
one or more power circuits configured to receive power from the autonomous vehicle and distribute power to the vehicle management board; and
a third one or more connectors configured to interface with a fourth one or more connectors of the vehicle management board and distribute the power to the vehicle management board, wherein the fourth one or more connectors are configured to receive power from the first vehicle-specific board.

7. The modular vehicle management system of claim 6, wherein the one or more power circuits include at least one power conversion circuit configured to convert power from a first type provided by the autonomous vehicle to a second type based on a board type of the first vehicle-specific board.

8. The modular vehicle management system of claim 1, wherein the one or more vehicle operation connections communicate instructions to the one or more controllers of the autonomous vehicle based on the control data.

9. The modular vehicle management system of claim 1, wherein the vehicle management board further comprises:
one or more computer-readable storage mediums storing program instructions,
wherein the one or more processors are configured to execute the program instructions to cause the vehicle management board to:
receive the operational data from the first vehicle-specific board;
generate the control data; and
send the control data to the first vehicle-specific board.

10. The modular vehicle management system of claim 9, wherein:
the vehicle management board further comprises field programmable gate array (“FPGA”) architecture; and
the one or more processors are further configured to execute the program instructions to cause the vehicle management board to:
configure the FPGA architecture based on at least one of:
the vehicle sensor data;
the operational data; or
a board type of the first vehicle-specific board.

11. The modular vehicle management system of claim 1, wherein the autonomous vehicle communicates with at least one external computing device configured to integrate data received from the autonomous vehicle and at least one of:
a different external computing device;
a different vehicle; or
an external sensor.

12. The modular vehicle management system of claim 1, wherein the autonomous vehicle communicates with a second autonomous vehicle with a second modular vehicle management system comprising:
a second vehicle management board configured to interface with any of the plurality of vehicle-specific boards including at least the first vehicle-specific board and a second vehicle-specific board; and
the second vehicle-specific board interfaced with the second vehicle management board.

13. The modular vehicle management system of claim 1, wherein the autonomous vehicle communicates with at least one external sensor.

14. A method comprising:
by a vehicle management board:
receiving operational data from a first vehicle-specific board;
generating, based at least on the operational data and vehicle sensor data, control data; and
transmitting the control data to the first vehicle-specific board; and
by the first vehicle-specific board:
receiving the operational data from one or more computing devices;
conveying the operational data to the vehicle management board;
receiving the control data from the vehicle management board; and
based on the control data, conveying instructions to one or more controllers of an autonomous vehicle.

15. The method of claim 14, wherein generating the control data comprises:
determining, based at least in part on the operational data and the vehicle sensor data, a desired operation for the autonomous vehicle;
determining, based at least in part on the operational data and the vehicle sensor data, that the desired operation passes a safety critical test; and
based on the desired operation passing the safety critical test, generating the control data, wherein the control data is configured to control the autonomous vehicle to perform the desired operation.

16. The method of claim 14, further comprising:
configuring a field programmable gate array (“FPGA”) of the vehicle management board based on at least one of:
the vehicle sensor data;
the operational data; or
a board type of the first vehicle-specific board.

17. The method of claim 14, wherein the autonomous vehicle is unmanned.

18. The method of claim 14, further comprising:
communicating with at least one external computing device configured to integrate data received from the autonomous vehicle and at least one of:
a different external computing device;
a different autonomous vehicle; or
an external sensor.

19. The method of claim 14, further comprising:
communicating with a second autonomous vehicle.

20. The method of claim 14, further comprising:
communicating with at least one external sensor.
